(19) United States
(12) Patent Application Publication
(10) Pub. No.: US 2024/0006644 A1
(43) Pub. Date: Jan. 4, 2024

(54) OXYANION-BASED ENERGY STORAGE

(71) Applicant: FORM ENERGY, INC., Somerville, MA (US)

(72) Inventors: Merrill K. CHIANG, Weston, MA (US); Liang SU, Medfield, MA (US); Yet-Ming CHIANG, Weston, MA (US); William Henry WOODFORD, Somerville, MA (US); Kailash RAMAN, Glendale, AZ (US)

(21) Appl. No.: 18/300,970

(22) Filed: Apr. 14, 2023

Related U.S. Application Data
(63) Continuation-in-part of application No. 18/049,957, filed on Oct. 26, 2022.
(60) Provisional application No. 63/381,099, filed on Oct. 26, 2022.
(60) Provisional application No. 63/363,020, filed on Apr. 14, 2022.
(60) Provisional application No. 63/273,746, filed on Oct. 29, 2021.

(51) Int. Cl. H01M 8/18; H01M 4/96; H01M 4/90

(52) U.S. Cl. CPC H01M 8/188; H01M 4/96; H01M 4/9016; H01M 2004/8689

(57) ABSTRACT

Systems, methods, and device of the various embodiments may support energy storage devices in which electrochemical oxidation and reduction of one or more redox-active oxyanions occurs during charging and/or discharging of the energy storage device.

### RELATED APPLICATIONS

This application claims the benefit of priority to U.S. Provisional Patent Application No. 63/381,099, filed Oct. 26, 2022, and to U.S. Provisional Patent Application No. 63/363,020, filed Apr. 14, 2022, and is a continuation-in-part of, and claims priority to, U.S. patent application Ser. No. 18/049,957, filed Oct. 26, 2022, which claims the benefit of priority to U.S. Provisional Patent Application No. 63/273,746, filed Oct. 29, 2021, the entire contents of which are hereby incorporated by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultralong (collectively, >8 h) energy storage systems. Of benefit are potentially low-cost rechargeable battery chemistries that can enable long duration large scale energy storage.

### SUMMARY

Systems, methods, and device of the various embodiments may support energy storage devices in which electrochemical oxidation and reduction of one or more redox-active oxyanions occurs during charging and/or discharging of the energy storage device.

Various embodiments may include an energy storage device, comprising: at least one electrode configured such that electrochemical oxidation and reduction of one or more redox-active oxyanions occurs during charging and/or discharging of the energy storage device.

Various embodiments may include an energy storage device, comprising: negative electrode materials comprising sulfate and sulfite; and positive electrode materials comprising oxygen, wherein the energy storage device is configured to be rechargeable.

Various embodiments include halogen oxyanion-based electrodes and related batteries and systems. Various embodiments include electrochemical electrode reactions comprising halogen oxyanions. Various embodiments may include an electrode in an electrochemical device comprising an electrode reaction, or redox reaction, of a halogenated oxyanion species.

Various embodiments include reversible Cl(III)/Cl(IV) electrodes, processes for making reversible Cl(III)/Cl(IV) electrodes, and batteries and battery systems including reversible Cl(III)/Cl(IV) electrodes. Various embodiments may include a direct reversible Cl(III)/Cl(IV) cathode, for example coupled with ClO₂ storage, in a battery and/or battery system. Various embodiments may include an indirect Cl(III)/Cl(IV) electrode, for example without ClO₂ storage, in a battery and/or battery system. Such indirect Cl(III)/Cl(IV) electrode may be, for example, based on a 3-Chemical Chlorine Dioxide Reaction.

A first example implementation may include an alkaline electrolyte with a polysulfide electrode and NaClO₂ electrode. Such an example has been observed to have an open circuit voltage (OCV) of 1.50 volts (V). A second example implementation may include an alkaline electrolyte with an iron electrode and NaClO₂ electrode. Such an example is calculated to have an OCV of 1.84V. A third example implementation may include a neutral electrolyte with an iron electrode and NaClO₂ electrode. Such an example is calculated to have an OCV of 1.39V. A fourth example implementation may include an acidic electrolyte with a hydrogen electrode and NaClO₂ electrode. Such an example is calculated to have an OCV of 1.27V.

Various embodiments may include an electrochemical system, comprising: a first electrode; and a second electrode, wherein the electrochemical system stores energy and/or discharges energy by an electrode reaction of a halogenated oxyanion species. In some embodiments, the storing of energy and/or the discharging of energy by the electrode reaction of the halogenated oxyanion species comprises storing energy and discharging energy by a reversable electrode reaction between a chlorine containing ion and chlorine dioxide. In some embodiments, the chlorine containing ion comprises a salt. In some embodiments, the salt is an alkali metal salt. In some embodiments, the electrochemical system comprises a storage battery. In some embodiments, the system may further comprise a current collector comprising a metal or metal compound. In some embodiments, the current collector comprises carbon. In some embodiments, the system is a bulk energy storage system is a long duration energy storage (LODES) system.

Various embodiments may include a method, comprising: storing and/or discharging energy by an electrode reaction of a halogenated oxyanion species. In some embodiments, storing and/or discharging energy by an electrode reaction of a halogenated oxyanion species comprises storing and/or discharging energy by a reversable electrode reaction between a chlorine containing ion and chlorine dioxide. In some embodiments, the chlorine containing ion comprises a salt. In some embodiments, the salt is an alkali metal salt. In some embodiments, the storing and/or discharging are performed as part of operating a battery in a bulk energy storage system. In some embodiments, the bulk energy storage system is a long duration energy storage (LODES) system.

Various embodiments may include an energy storage device, comprising: negative electrode materials; and positive electrode materials comprising chlorine dioxide and chlorite, wherein the energy storage device is configured to be rechargeable.

### DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIGS. 1-4 are schematic views of electrochemical energy storage devices, according to various embodiments of the present disclosure.

FIGS. 5A and 5B are schematic views showing discharging and charging of an energy storage device of FIG. 1, according to various embodiments of the present disclosure.

FIGS. 6A and 6B are schematic views showing discharging and charging of an energy storage device of FIG. 2, according to various embodiments of the present disclosure.

FIGS. 7-15 illustrate various example systems in which one or more aspects of the various embodiments may be used as part of bulk energy storage systems.

FIG. 16 is a schematic representation of an electrochemical cell, according to various embodiments of the present disclosure.

FIG. 17 is a graph of cyclic voltammetry results for NaClO₂ bearing solutions in acidic and alkaline electrolyte.

FIG. 18 is a schematic representation of an iron-chlorine dioxide battery and reactions occurring during discharge or charge.

FIG. 19A is a schematic representation of a formation reaction in which chlorine dioxide is produced.

FIG. 19B is a schematic representation of a battery configuration in which a separate ClO₂-enriched phase is separated from the electrolyte due to differences in density and, thus, less likely to come into contact with the current collectors or electrodes.

FIG. 20 is a schematic representation of an Fe-chlorine dioxide battery

FIG. 21 is a schematic representation of an Fe-chlorine dioxide battery cell including a co-planar arrangement of electrodes, optional separator layer, and chlorine dioxide layer separated from liquid electrolyte of the cell under the force of gravity due to a density difference.

FIG. 22A is a Pourbaix diagram showing that highly concentrated electrolytes facilitate higher cell voltages by suppressing electrolyte decomposition.

FIG. 22B is a schematic diagram of oxygen evolution reaction rates for a high-salt concentration electrolyte (10 M NaClO₄) and a lower-salt concentration electrolyte (1 M NaClO₄) when electrical potential exceeds equilibrium potential for the oxygen evolution reaction.

FIG. 23A is a schematic representation of operation of a battery system in which ClO₂ is produced as needed to supply the reaction of ClO₂ to ClO₂⁻, with the battery system shown charging.

FIG. 23B is a schematic representation of operation of the battery system of FIG. 23A during discharging.

FIG. 23C a schematic representation of operation of the battery system of FIG. 23A during discharging, with the battery system comprising additional storage tanks.

FIG. 24A is a graph showing cyclic voltammetry (CV) of cells including 10 mM NaClO₂ on a glassy carbon electrode (GCE, 3 mm dia.) at a scan rate of 100 mV/sec.

FIG. 24B is a graph showing CV for 10 mM NaClO₂ on a glassy carbon electrode (GCE, 3 mm dia.) in 1M NaCl electrolyte at different scan rates.

FIG. 24C is a graph showing a Randles-Sevcik analysis based on data from FIG. 24B.

FIG. 25 is a graph showing cyclic voltammetry (CV) results of 10 mM NaClO₂ in 1M KOH solution using a glassy carbon electrode (3 mm dia.) at a scan rate of 100 mV/sec in a water-jacketed glass cell, at 5° C. and 20° C.

FIG. 26A is a perspective view of a planar Zn/ClO₂ battery cell.

FIG. 26B is a front, partially transparent view of the planar Zn/ClO₂ battery cell of FIG. 26A.

FIG. 26C is an exploded view of the planar Zn/ClO₂ battery cell of FIG. 26A.

FIG. 27A is a graph of the charge and discharge capacity of the full cell of FIGS. 26A-26C.

FIG. 27B is a graph of the charge and discharge capacity of the cathode of the full cell of FIGS. 26A-26C versus a reference electrode capacity.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but rather to enable a person skilled in the art to make and use this disclosure. Unless otherwise noted, the accompanying drawings are not drawn to scale.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present disclosure. These examples are for illustrative purposes, may be prophetic, and should not be viewed as limiting, and do not otherwise limit the scope of the present disclosure.

It is noted that there is no requirement to provide or address the theory underlying the novel and groundbreaking processes, materials, performance or other beneficial features and properties that are the subject of, or associated with, embodiments of the present disclosure. Nevertheless, various theories are provided in this specification to further advance the art in this area. The theories put forth in this specification, and unless expressly stated otherwise, in no way limit, restrict or narrow the scope of protection to be afforded the claimed invention. These theories may not be required to utilize the present disclosure. It is further understood that the present disclosure may lead to new, and heretofore unknown theories to explain the function-features of embodiments of the methods, articles, materials, devices, and system of the present disclosure, and such later developed theories shall not limit the scope of protection afforded the present disclosure.

The various embodiments of systems, equipment, techniques, methods, activities, and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present disclosure should not be limited to a particular embodiment, configuration or arrangement that is set forth in a particular embodiment, example, or in an embodiment in a particular figure.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Embodiments of the present disclosure include apparatuses, systems, and methods for long-duration, and ultra-long-duration energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage devices or systems may refer to energy storage devices or systems that may be configured to store energy over time spans of days, weeks, or seasons. For example, the energy storage devices or systems may be configured to store energy generated by solar cells during the summer months, when sunshine is plentiful and solar power generation exceeds power grid requirements, and discharge the stored energy during the winter months, when sunshine may be insufficient to satisfy power grid requirements.

Other embodiments include backup power for telecommunications, data centers, electronic devices, transportation signals, medical facilities, or buildings. The duration of power delivery from the battery may range from a few minutes to a few hours. The durations of energy storage and/or power delivery described herein are provided merely as examples and are not intended to be limiting.

Various embodiments provide systems for ultra-long (days, weeks, months, years) energy storage based upon electrochemical oxidation and reduction of oxyanions that include, but are not limited to, electrochemical reactions of aqueous solutions of nitrogen, sulfur, and phosphorus oxyanions. The present systems have advantages in cost, scalability, and safety compared to existing energy storage technologies.

Existing electrochemical energy storage technologies have a high cost of energy capacity (S/kWh), making it economically infeasible to scale them to durations greater than 8 hours. This high cost is largely attributed to the use of expensive raw materials as energy storage media. The presently described system offers ultra-low cost electrochemical energy storage by utilizing abundant oxyanion chemical feedstocks for energy storage.

Various embodiments may include chemical reactants for such an electrochemical energy storage system, supporting materials, such as electrolytes and additives, and/or components of an electrochemical cell or energy storage system. Various embodiments may include the electrochemical cell and its design, as well as auxiliary subsystems aiding in the function of the energy storage system. Various embodiments may include a system comprising the electrochemical cell and subsystems aiding in its function, including but not limited to, subsystems delivering and removing gaseous reactants, subsystems delivering and removing liquid reactants, subsystems providing for interconnection of the energy storage system with electricity inputs and outputs, thermal management subsystems, and/or subsystems providing for electrical or mechanical control of the system, including but not limited to battery management systems (sometimes referred to as BMSs). Various embodiments may also include systems comprising said energy storage system and a source of electricity, including but not limited to a source of renewable electricity.

As used herein the term “redox” may refer to a reduction-oxidation reaction in which a reduction process and an oxidation process occur at the same time. During redox, one reactant loses an electron, thereby being oxidized (i.e., entering an oxidation state) and the other reactant gains an electron, thereby being reduced (i.e., entering a reduction state). Redox-active species may be species changing oxidation state (e.g., undergoing reduction or undergoing oxidation) in a reduction-oxidation reaction.

Various embodiments include electrodes, electrochemical couples, batteries, and energy storage systems comprising redox-active oxyanions, including without limitation nitrate (NO₃²⁻), nitrite (NO₂²⁻), sulfate (SO₄²⁻), sulfite (SO₃²⁻), hyposulfite (SO₂²⁻), phosphate (PO₄³⁻), phosphite (PO₃³⁻), hypophosphite (PO₂³⁻), and the like, or combinations thereof. In some embodiments, the redox-active oxyanions may include more highly oxidized or more highly reduced species such as, peroxodisulfate (S₂O₈²⁻), ammonia (NH₃), ammonium (NH₄⁺), or sulfides such as S₂⁻ or HS₂. In some embodiments, the redox-active oxyanions may include chlorite (ClO₂₋), chlorate (ClO₃⁻), chlorine dioxide (ClO₂), hypochlorite (ClO⁻), and the like, or combinations thereof. In some embodiments, the operation of the energy storage system comprises reversible reduction/oxidation (redox) of one or more of the oxyanion species. In some embodiments, the source of the redox-active species is a salt, including but not limited to a sodium salt, such as sodium nitrate, sodium nitrite, sodium sulfate, sodium sulfite, analogous potassium salts, or an ammonium salt such as ammonium nitrate or ammonium sulfate.

In various embodiments, provided are energy storage devices such as electrochemical cells (e.g., batteries) that include an anode, a cathode, and an aqueous electrolyte in which the redox-active oxyanions may be dissolved. The redox-active oxyanions may be considered to be an electrode active material of either the anode or the cathode, depending on the configuration of the battery.

In some embodiments an energy storage system comprises an electrochemical cell (e.g., battery) or stack or electrochemical cells in which aqueous electrolyte solutions comprising oxyanion compounds are stationary (that is, not pumped). In other embodiments, the aqueous electrolyte solutions are pumped or otherwise moved through the electrochemical stack. In some embodiments, the batteries may operate using a gaseous reactant, such as air, oxygen, or ammonia. As used herein, the term “air” may refer to a general mixture of gases making up an atmosphere, such as Earth's atmosphere (e.g., largely nitrogen, oxygen, and other elements) or other atmospheres (e.g., extraterrestrial atmospheres, selected atmospheres, etc.). In some embodiments, gaseous reactants are passively delivered to the electrochemical cells (that is, are not pumped or otherwise forced under pressure), whereas in other embodiments, said gaseous reactants are pumped or otherwise moved to or within the electrochemical cell. In some embodiments, reduction and oxidation of the gaseous reactant is conducted at a single electrode (also referred to as a bi-functional electrode). In other embodiments, reduction and oxidation of the gaseous reactant are carried out at separate electrodes. In particular embodiments, a gas-diffusion layer (GDL) electrode is used for reduction of the gaseous reactant, and/or a gas-evolution electrode is used for oxidation of the gaseous reactant. In one particular embodiment, the gaseous reactant is oxygen, and the GDL electrode is an oxygen reduction reaction (ORR) electrode, and the gas-evolution electrode is an oxygen evolution (OER) electrode.

Existing scientific literature teaches that sulfite oxidation on graphite is electrolytically irreversible. In contrast, the present inventors surprisingly found that the oxidation of sulfite to sulfate in alkaline solution (e.g., pH=13) occurs reversibly at about +0.6 V vs SHE (standard hydrogen electrode) at room temperature, while the oxygen evolution reaction (OER) occurs at about +1.4 V vs SHE. Various embodiments may include a rechargeable sulfate-oxygen, or sulfate-air, battery comprising sulfate and sulfite as the negative electrode materials and oxygen and/or air, as the positive electrode materials. In some embodiments, such a sulfate-oxygen, or sulfate-air, battery may have an open-cell voltage or operating voltage of about 0.8 V.

In some embodiments, provided are energy storage devices, such as electrochemical cells (e.g., batteries) that include stationary electrolytes (e.g., the electrolytes are not pumped or otherwise circulated during operation of the battery). In other embodiments, provided are energy storage devices that include a circulated electrolyte. For example, a volume of the electrolyte may be circulated between an electrochemical cell or stack of electrochemical cells and an electrolyte reservoir. In some embodiments, a gaseous reactant, such as air, oxygen, or ammonia, may be provided to an electrochemical cell. In some embodiments, gaseous reactants are passively delivered to the electrochemical cell (that is, are not pumped or otherwise injected), whereas in other embodiments, the gaseous reactants are pumped or otherwise provided to or circulated within the electrochemical cell. In some embodiments, reduction and oxidation of the gaseous reactant is conducted at a single electrode (also referred to as a bi-functional electrode). In other embodiments, reduction and oxidation of the gaseous reactant are carried out at separate electrodes. In particular embodiments, a gas-diffusion layer (GDL) electrode is used for reduction of the gaseous reactant, and/or a gas-evolution electrode is used for oxidation of the gaseous reactant. In one particular embodiment, the gaseous reactant is oxygen, and the GDL is an oxygen reduction reaction (ORR) electrode, and the gas-evolution electrode is an oxygen evolution reaction (OER) electrode.

In various embodiments, an electrode, electrochemical cell, battery, and/or energy storage system may be configured such that electrochemical oxidation and reduction of one or more redox-active oxyanions occurs during charging and/or discharging of the energy storage device. In some embodiments, the electrode, electrochemical cell, battery, and/or energy storage system may be configured such that electrochemical conversions between nitrate, nitrite, and/or ammonia occur during charging and/or discharging. In some embodiments, an electrode may include an aqueous solution of sodium nitrate, potassium nitrate, lithium nitrate, magnesium nitrate, calcium nitrate, calcium ammonium nitrate, sodium nitrite, potassium nitrite, lithium nitrite, or mixtures thereof. In some embodiments, the electrode, electrochemical cell, battery, and/or energy storage system may be configured such that electrochemical conversions between sulfate, sulfite, hyposulfite, thiosulfate, dithionite, and/or hydrogen sulfide occur during charging and/or discharging of the energy storage device. In some embodiments, an electrode may include an aqueous solution of an aqueous solution of sodium sulfate, potassium sulfate, magnesium sulfate, ammonium sulfate, sodium sulfite, potassium sulfite, or mixtures thereof. In some embodiments, the electrode, electrochemical cell, battery, and/or energy storage system may be configured such that electrochemical conversions between phosphate, phosphite, and hypophosphite occur during charging and/or discharging of the energy storage device. In some embodiments, an electrode may include an aqueous solution of sodium phosphate, potassium phosphate, disodium hydrogen phosphite, diammonium hydrogen phosphite, or mixtures thereof.

In various embodiments, an electrode, electrochemical cell, battery, and/or energy storage system may comprise one or more biomolecules, enzymes, and/or microorganisms which aid the reduction or oxidization of one or more redox-active species of the electrode, the electrochemical cell, the battery, and/or the energy storage system. As used herein “microorganisms” (also referred to as microbes) refers to microbial organisms, such as bacteria, protozoa, algae, viruses, etc. According to such embodiments, the redox-active species of may include any electrode-active compound serving as a positive or negative electrode, and which stores charge by undergoing changes in oxidation state. Such electrode-active compounds may comprise a solid, liquid, or gas.

Solid electrode-active compounds may comprise intercalation compounds in which the insertion or removal of an ion is accommodated by a change in the valence state of the host, non-limiting examples of which include lithium, sodium, or proton insertion cathodes and anodes used in lithium-ion, sodium-ion, nickel metal hydride, and Zn—MnO2 alkaline cells. Solid electrode-active compounds may comprise compounds undergoing a phase change upon incorporating a working ion, non-limiting examples of which include the oxidation of zinc metal to zincate, oxidation of iron to iron hydroxide (Fe(OH)2), iron oxyhydroxide (FeOOH), or iron oxide (e.g., Fe3O4 or Fe2O3).

Liquid electrode-active compounds may comprise neat or dissolved salts, including nitrogen, sulfur, and phosphorus oxyanions, ammonium, ammonia, and sulfide, as described elsewhere herein. Liquid electrode-active compounds may also include molecular species dissolved in a liquid solvent, such as ammonia, nitrogen, oxygen, chlorine, or bromine dissolved in a nonpolar solvent, or used in the form of a liquid condensed phase including liquid ammonia, liquid nitrogen, liquid oxygen, liquid chlorine, and the like.

Gaseous electrode-active compounds may include molecular species such as ammonia, nitrogen, chlorine, and oxygen in gaseous form.

In various embodiments, the oxidation or reduction of any of the aforementioned electrode-active compounds (e.g., the solid, liquid, and/or gaseous electrode-active compounds discussed above) may be aided (e.g., facilitated, catalyzed, otherwise improved, etc.) by biomolecules, enzymes, and/or microorganisms (e.g., bacteria, etc.).

In some embodiments, the electrode, the electrochemical cell, the battery, and/or the energy storage system may comprise one or more biomolecules, enzymes, microorganisms, or any combination thereof. In certain embodiments, the biomolecules, enzymes, and/or microorganisms (e.g., bacteria, etc.) may serve to catalyze the reduction or oxidation of redox-active oxyanions or other species, or to reduce or oxidize said oxyanions or redox-active species by, for example, carrying out electron transfer reactions. As a non-limiting example, sulfate-reducing and nitrate-reducing bacteria are known and may be used to facilitate or promote the reduction of sulfate to sulfite or hyposulfite, or of nitrate to nitrite. In some embodiments, the microorganisms used are selected from those present and active in environmental or natural denitrification processes, including those where nitrates and nitrates may be reduced to gaseous nitrogen species. In other embodiments, the microorganisms used are selected from those present and active in the natural sulfur cycle.

In various embodiments, the microorganisms used are selected from those tolerant of the chemical and electrochemical operating conditions of the battery. As a non-limiting example of such selection, bioelectrochemical reduction of nitrate has been observed to depend on whether sulphate is simultaneously present, and on the value of the electrical potential. For example, in the absence of sulphate, Shinella-like and Alicycliphilus-like bacteria may be exclusively found on carbon felt cathodes, while Ochrobactrum-like and Sinorhizobium-like bacteria may be found on the cathodes irrespective of sulphate presence and over a range of cathode potentials. As another example of selection of microorganisms for the purposes of the disclosure, aerobic nitrate reduction, defined as reduction in the presence of atmospheric oxygen, is preferably conducted by certain soil bacteria in the genera Pseudomonas, Aeromonas, and Moraxella. In some embodiments, said microorganisms may be anaerobic, and in other embodiments, said microorganisms may be aerobic.

Accordingly, the preferred bacteria for oxyanion reduction in some embodiments of the disclosure may be selected depending on atmospheric conditions, electrolyte composition, pH, and/or the operating electrical potential of a battery. In various embodiments, said redox reactions may be carried out in acidic solution, near neutral or neutral pH solution, or alkaline (basic) solution. In some embodiments, the pH may be between 7 and 14, and the microorganisms used to facilitate reduction or oxidation may selected, or genetically evolved, to be tolerant of high pH environments.

In some embodiments, the electrodes, electrochemical cells, batteries, or energy storage systems of the present disclosure comprise microorganisms from the group comprising sulphate-reducing bacteria (SRB). SRB are anaerobic microorganisms that are known to play an important role in both the sulfur and carbon cycles. In various embodiments, SRB may be present in the electrodes, electrochemical cells, batteries, or energy storage systems of the present disclosure to facilitate redox processes of the redox-active electrodes in accordance with various embodiments. For example, SRBs may include individually, or in combinations, Archaeoglobus fulgidus DSM 4304, Caldivirga maquilingensis IC-167, Desulfotomaculum reducens MI-1, Desulfovibrio vulgaris subsp. vulgaris strain Hildenborough, Desulfovibrio vulgaris subsp. vulgaris DP4, Desulfovibrio desulfuricans G20, Desulfotalea psychrophila LSv54, Synthrophobacter fumaroxidans MPOB, or the like.

In some embodiments, the anode and/or cathode may comprise a dispersed metal, including but not limited to nanoparticles of iron. In certain embodiments, the efficacy of the microorganism(s) in promoting reduction or oxidation is improved by the presence of dispersed metal. For example, it has been found that the microbial reduction of nitrate is enhanced in the presence of nanoparticulate iron.

Certain embodiments of the disclosure comprise a rechargeable battery wherein charging or partial charging, including the reduction of self-discharge, is accomplished by microorganisms that reduce one or more oxidized discharge products of the battery. For example, in embodiments where discharge of the battery is accommodated by the oxidation of one or more of the herein described redox-active species, charging of the battery may be accomplished by microorganisms which reduce said redox active species.

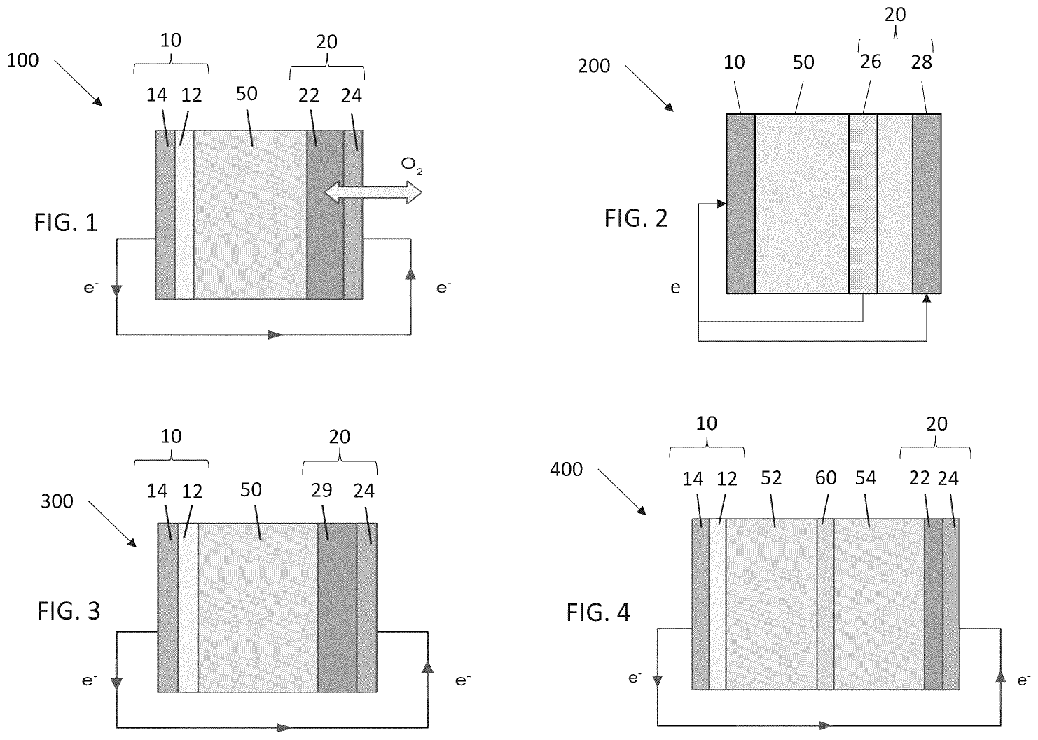

FIG. 1 is a schematic view of an air battery 100, according to various embodiments of the present disclosure. Referring to FIG. 1, the air battery 100 may include an anode 10, a cathode 20 (e.g., an air cathode), and an electrolyte 50 disposed therebetween. The anode 10 may include an anode catalyst 12 disposed on a current collector 14. The current collector 14 may comprise graphite, glassy carbon, disordered carbon, graphene, graphene oxide, carbon nanofibers, carbon nanotubes, and/or other fullerenic carbons. The anode catalyst 12 may include, individually, or in combinations, Cu, Ag, Pt, Ti, Fe, Ru, a Cu/Ni alloy, or the like, for example.

The cathode 20 may be a bifunctional cathode operable as an oxygen reduction reaction (ORR) electrode during discharging and operable as an oxygen evolution reaction (OER) electrode during charging. The cathode 20 may include a cathode catalyst layer 22 disposed on a current collector 24. The current collector 24 may comprise graphite, glassy carbon, disordered carbon, graphene, graphene oxide, carbon nanofibers, carbon nanotubes, and/or other fullerenic carbons. The cathode catalyst layer 22 may include one or more catalysts such as Cu, Ag, Pt, Ti, Fe, Ru, a Cu/Ni alloy, combinations thereof, or the like, for example.

The electrolyte 50 may be an aqueous electrolyte comprising redox-active oxyanions, including, without limitation, nitrate (NO₃²⁻), nitrite (NO₂²⁻), sulfate (SO₄²⁻), sulfite (SO₃²⁻), hyposulfite (SO₂²⁻), phosphate (PO₄³⁻), phosphite (PO₃³⁻), hypophosphite (PO₂³⁻), and the like, or combinations thereof. In some embodiments the redox-active oxyanions may include more highly oxidized or more highly reduced species such as, peroxodisulfate (S₂O₈²⁻), ammonia (NH₃), ammonium (NH₄⁺), or sulfides such as S₂⁻ or HS₂. In some embodiments, the redox-active oxyanions may include chlorite (ClO2-), chlorate (ClO₃⁻), chlorine dioxide (ClO₂), hypochlorite (ClO⁻), and the like, or combinations thereof. A source of the redox-active species may be a salt, including but not limited to, a sodium salt, such as sodium nitrate, sodium nitrite, sodium sulfate, sodium sulfite, analogous potassium salts, or an ammonium salt such as ammonium nitrate or ammonium sulfate.

FIG. 2 is a schematic view of an air battery 200, according to various embodiments of the present disclosure. The battery 200 may be similar to the air battery 100, as such, only the differences therebetween will be discussed in detail.

Referring to FIG. 2, the air battery 200 may include a dual cathode 20 including an OEE electrode 26 and an ORR electrode 28. The OEE electrode 26 may be formed of a metal mesh, such as a Ni mesh, a Ni alloy mesh, or a stainless steel mesh, for example. The ORR electrode 28 may include a hydrophobic portion that is exposed to air and a hydrophilic portion that exposed to the electrolyte 50. The ORR electrode 28 may include ORR catalysts.

FIG. 3 is a schematic view of a battery 300, according to various embodiments of the present disclosure. The battery 300 may be similar to the air battery 100, as such, only the differences therebetween will be discussed in detail.

Referring to FIG. 3, the battery 300 may include a cathode 20 comprising a solid-state cathode material layer 29 and a current collector 24. The solid-state cathode material layer 29 may include cathode catalyst and/or a cathode active material selected from iron (III) and/or iron (II) cations, molecular chlorine/chloride, molecular bromine/bromide, and/or manganese (II) oxide/manganese (II) hydroxide, any combination thereof, or the like.

FIG. 4 is a schematic view of a battery 400, according to various embodiments of the present disclosure. The battery 400 may be similar to the air battery 100, as such, only the differences therebetween will be discussed in detail.

Referring to FIG. 4, the battery 400 may include an anolyte 52 (e.g., an aqueous analyte), and a catholyte 54 (e.g., an aqueous catholyte), and a separator 60 disposed therebetween. The separator 60 may be an ion exchange membrane, such as a Nafion™ membrane, available from The Chemours Company of Wilmington, Delaware, United States. The anolyte 52 may include redox-active oxyanions as discussed above. The catholyte 54 may include sodium sulfate, potassium sulfate, magnesium sulfate, ammonium sulfate, sodium sulfite, potassium sulfite, or mixtures thereof, or the like.

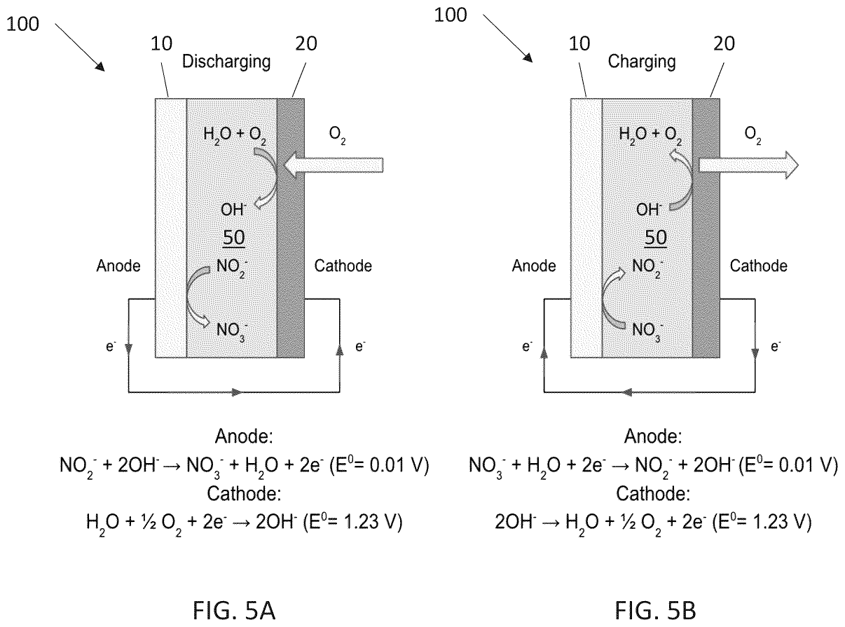

FIGS. 5A and 5B are schematic representations of discharging and charging, respectively, of the air battery 100 (shown in FIG. 1), using nitrogen compounds as active materials. In particular, the air battery 100 may reduce and oxidize mass-produced nitrogen compounds, which span a wide spectrum of oxidation states, to store and discharge power. For example, as shown in FIGS. 5A and 5B, the air battery 100 may operate using nitrates (NO₃⁻) and nitrites (NO₂⁻) as redox-active oxyanions and ambient air as a source of hydroxyl ions.

Nitrates (NO₃⁻) are the most oxidized class of nitrogen compounds. Nitrate compounds, such as sodium nitrate and potassium nitrate, are used widely in the fertilizer industry. They are readily soluble in water and demonstrate high chemical stability. Nitrates can undergo a two-electron reduction to become nitrites (NO₂—). Nitrites possess many similar traits as nitrates in terms of cost, solubility, and stability. Nitrites can undergo an additional six-electron reduction to become ammonia (NH₃). A variety of electrocatalysts can be used to perform reversible electrochemical conversions between these species in aqueous solutions.

As shown below, half reaction 1 occurs at the anode 10, with NO₃— being generated during discharging and NO₂— being generated during charging, and half reaction 2 occurs at the cathode 20, with oxygen being reduced during discharging (OH— generation and O₂ consumption) and with oxygen being evolved during charging (H₂O and O₂ generation), with the sum of reaction 1 and reaction 2 being net reaction 3:

NO₃_{^{−}}_{(aq)}+H₂O_{(I)}+2e⁻↔NO₂_{^{−}}_{(aq)}+2OH⁻_{(aq)}; Reaction 1:

2OH⁻_{(aq)}↔H₂O_{(I)}+½O_{2(g)}+2e⁻; and Reaction 2:

NO₃_{^{−}}_{(aq)}↔NO₂_{^{−}}_{(aq)}+½O_{2(g)}. Reaction 3:

The charge process (energy storing) drives net reaction 3 to the right, creating nitrite (NO₂—) and oxygen. The discharge process is the oxidation of nitrite to create nitrate (NO₃—). The standard reduction potential of reaction 1 above is 0.01 V, while that of reaction 2 is 1.23 V. These two half reactions sum to the overall cell reaction 3, with a standard potential of 1.22 V.

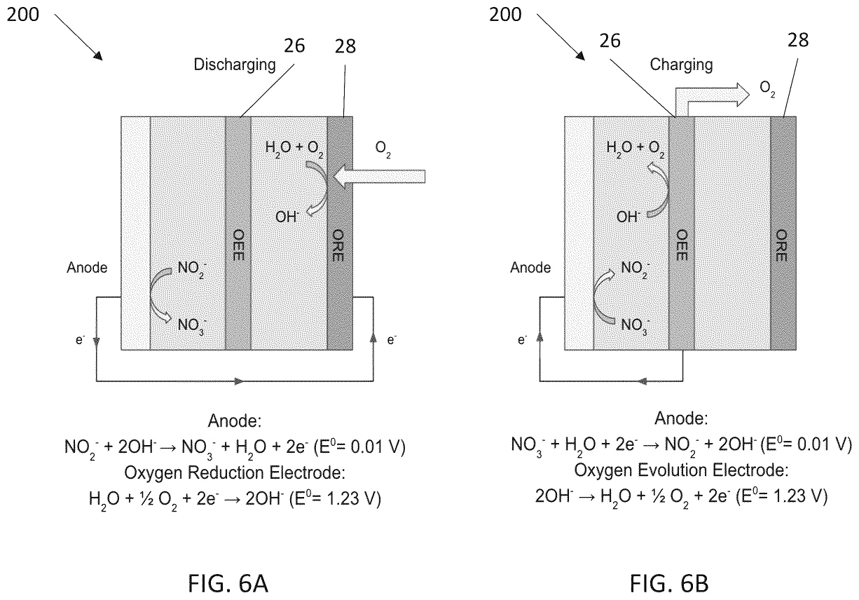

FIGS. 6A and 6B are schematic representations of discharging and charging, respectively, of the air battery 200 (shown in FIG. 2), using nitrogen compounds as active materials. As shown in FIGS. 6A and 6B, during discharging, hydroxyl generation occurs at the ORR electrode 28, and during charging, oxygen evolution reactions occur at the OEE electrode 26. In other words, the charging and discharging reactions are split between the two cathode electrodes 26, 28, which may reduce impedance and improve power storage efficiency.

The following Table 1 includes oxyanion electrode reactions and corresponding battery components that may be used in various embodiments to store and discharge power in electrochemical cells of the present disclosure.

TABLE 1

| | E⁰ | | | | |
|---|---|---|---|---|---|
| Half Reactions | (V) | Reagents | Catalysts | Electrode | Phase |
| NO₃⁻ + H₂O + | 0.01 | NaNO₃, KNO_{3,} | Cu, Ag, | Anode, | Aqueous |
| 2e⁻ ↔ NO₂⁻ + | | NH₄NO₃, LiNO₃, | Pt, Cu/Ni | Cathode | |
| 2OH⁻ | | Mg(NO₃)₂, | alloy | | |
| | | Ca(NO₃)₂, | | | |
| | | Ca(NO₃)₂/NH₄NO₃ | | | |
| NO₃⁻ + 6H₂O + | −0.12 | NaNO₃, KNO₃, | Cu/Ni | Anode, | Aqueous, |
| 8e⁻ ↔ NH₃ + | | NH₄NO₃, LiNO₃, | alloy, Ti, | Cathode | gas/liquid |
| 9OH⁻ | | Mg(NO₃)₂, | Fe, Ru | | |
| | | Ca(NO₃)₂, | | | |
| | | Ca(NO₃)₂/NH₄NO₃ | | | |
| NO₂⁻ + 5H₂O + | −0.16 | NaNO₂, KNO₂, | Cu/Ni | Anode, | Aqueous, |
| 6e⁻ ↔ NH₃ + | | LiNO₂ | alloy, Ti, | Cathode | gas/liquid |
| 7OH⁻ | | | Fe, Ru | | |
| SO₄²⁻ + H₂O + | −0.93 | Na₂SO₄, MgSO₄, | | Anode | Aqueous |
| 2e⁻ ↔ SO₃²⁻ + | | K₂SO₄, (NH₄)₂SO₄ | | | |
| 2OH⁻ | | | | | |
| 2SO₃²⁻ + 2H₂O + | −1.12 | Na₂SO₃, K₂SO₃ | | Anode | Aqueous |
| 2e⁻ ↔ S₂O₄²⁻ + | | | | | |
| 4OH⁻ | | | | | |
| 2SO₃²⁻ + 3H₂O + | −0.57 | Na₂SO₃, K₂SO₃ | | Anode | Aqueous |
| 4e⁻ ↔ S₂O₃²⁻ + | | | | | |
| 6OH⁻ | | | | | |
| SO₄²⁻ + 6H₂O + | −0.22 | Na₂SO₄, MgSO₄, | | Anode | Aqueous, |
| 8e⁻ ↔ H₂S + | | K₂SO₄, (NH₄)₂SO₄ | | | gas |
| 10OH⁻ | | | | | |
| PO₄³⁻ + 2H₂O + | −1.05 | Na₃PO₄, K₂PO₄ | | Anode | Aqueous |
| 2e⁻ ↔ HPO₃²⁻ + | | | | | |
| 3OH⁻ | | | | | |
| HPO₃⁻³ + H₂O + | −0.93 | Na₂HPO₃, | | Anode | Aqueous |
| 2e⁻ ↔ HPO₂⁻³ + | | (NH₄)₂HPO₃ | | | |
| 2OH⁻ | | | | | |

As shown in Table 1, in some embodiments, ammonia may be oxidized during discharging of an electrochemical cell to generate nitrates and/or nitrites, which may be reduced during charging of the cell to generate ammonia. Similar oxidation and reduction reactions of sulfur species may also occur during charging and discharging of an electrochemical cell.

The following Table 2 includes other electrode reactions that may be used to store and discharge power in electrochemical cells of the present disclosure.

TABLE 2

| Half Reaction | E⁰ (V) | Reagent | Electrode | Phase |
|---|---|---|---|---|
| H₂O + ½ O₂ + 2e⁻ ↔ | 0.40 | O₂ | Cathode | Gas |
| 2OH⁻ | | | | |
| Fe³⁺ + e⁻ ↔ Fe²⁺ | 0.77 | FeCl₂ | Cathode | Aqueous |
| Cl₂ + e⁻ ↔ 2Cl⁻ | 1.34 | FeCl₂ | Cathode | Aqueous, Gas |
| Br₂ + e⁻ ↔ 2Br⁻ | 1.08 | FeBr₂ | Cathode | Aqueous, |
| | | | | Liquid |
| MnO₂ + 2H₂O + 2e⁻ ↔ | 0.56 | MnO₂ | Cathode | Solid |
| Mn(OH)₂ + 2OH⁻ | | | | |

According to various embodiments, the energy capacity of a battery can be increased at a low marginal cost, which enables energy storage for long durations. Electrochemical energy is stored in a concentrated aqueous solution (containing dissolved oxyanion and hydroxide species) and air (containing molecular oxygen). In some embodiments, the aqueous solution may comprise or consist of water and a low-cost chemical feedstock. Therefore, the anode energy capacity can be increased at a low cost by increasing the volume of this low-cost solution. Meanwhile, the air cathode has an indefinite supply of oxygen. The scalability of energy capacity allows the energy storage device to deliver power for long durations (>8 hrs) at a low system cost.

Another advantage of the present disclosure is its limited potential for self-discharge. The aqueous electrolyte may include of a mixture of oxyanions at various oxidation states. Due to the stability of these species, all of these species can remain in the electrolyte simultaneously without undergoing self-discharge reactions. The system can remain in a charged state for long periods of time, on the order of weeks, months, and years. This facilitates smoothing the seasonal and inter-year variability of abundant but non-dispatchable energy sources such as wind, solar, or hydroelectric power. However, the present disclosure is not restricted to use over long durations and may be used over any charge or discharge duration to which a storage battery may be applied.

As the present disclosure can use common chemical feedstocks as energy storage media, it provides for greater operational flexibility than other energy storage technologies. For example, nitrites or ammonia (charged state species) may be generated by the intended energy storing process, or they may be sourced from any other available sources. Furthermore, the ammonia (or other storage chemical) synthesized by the energy storing processes, can be either used as a fuel for the electricity producing step or it may be used in other chemical processes or sold as a commodity chemical. Ammonia is most commonly produced today by the Haber-Bosch process, a thermochemical transformation which has been practiced on an industrial scale since the early twentieth century. Thus, the present technology provides advantages in flexible operation.

The theoretical volumetric energy density of the various embodiments of the present disclosure is also attractive. Consider the non-limiting case of a battery with an aqueous nitrate solution anode and air cathode. The charge storing capacity of concentrated aqueous sodium nitrate solution (10 M) is 214 Wh/L. This volumetric density is within the range of lithium ion technologies (100-200 Wh/L) and significantly higher than that of pumped hydro (0.25-1 Wh/L), the incumbent long duration storage technology.

Another advantage of the present disclosure may be improved safety. The electrolytes of various embodiments do not require flammable organic solvents. For example, aqueous electrolyte solutions including oxyanions pose limited fire risk, as compared to conventional electrolytes.

Various embodiments may provide devices and/or methods for use in bulk energy storage systems, such as long duration energy storage (LODES) systems, short duration energy storage (SDES) systems, etc. As an example, various embodiments may provide batteries for bulk energy storage systems, such as batteries for LODES systems, batteries for SDES systems, and/or batteries for systems needing power delivery for any time period. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

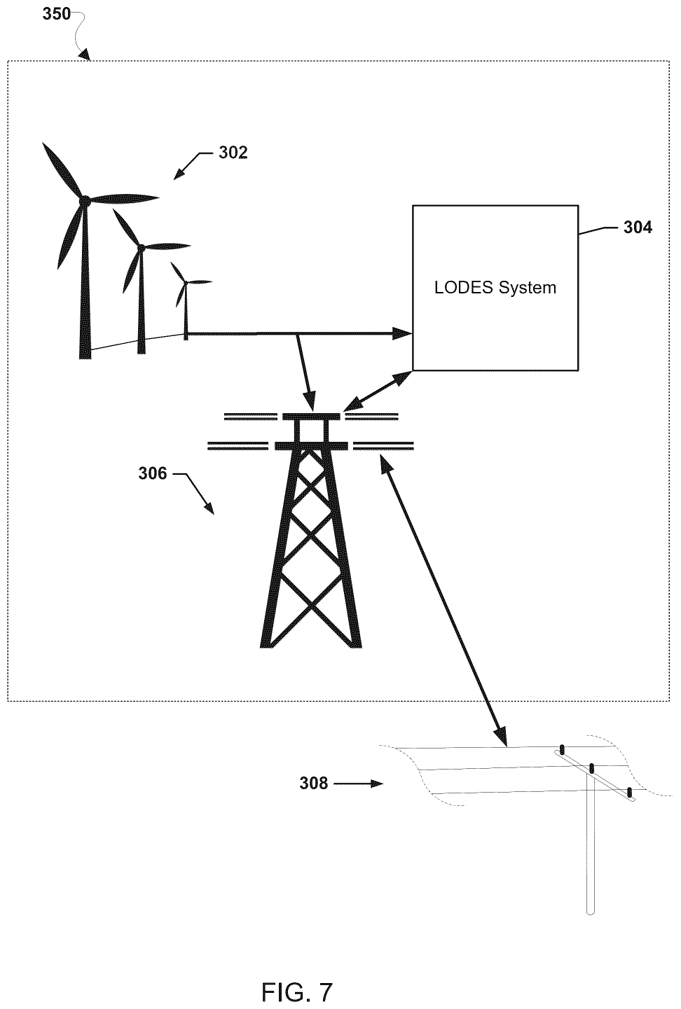

FIGS. 7-15 illustrate various example systems in which one or more aspects of the various embodiments may be used as part of bulk energy storage systems, such as LODES systems, SDES systems, systems needing power delivery for any time period, etc. For example, various embodiments described herein with reference to FIGS. 1-6B, such as electrochemical cells (or batteries) 100, 200, 300, 400, etc., may be used as batteries for bulk energy storage systems, such as LODES systems, SDES systems, systems needing power delivery for any time period, etc. and/or various electrodes as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc. As further examples, various embodiments described herein with reference to FIGS. 1A-3, such as electrochemical cells (or batteries) 100, 200, 300, 400, etc., may be used as batteries for backup power systems, such as backup power systems for telecommunications, data centers, electronic devices, transportation signals, medical facilities, or buildings. The duration of power delivery from the electrochemical cells (or batteries) 100, 200, 300, 400, etc. may be of any duration. The durations of energy storage and/or power delivery described herein generally, and specifically with reference to FIGS. 7-15, are provided merely as examples and are not intended to be limiting.

FIG. 7 illustrates an example system in which one or more aspects of the various embodiments may be used as part of bulk energy storage system. While FIG. 7 is discussed in relation to an example LODES system 304, the durations of energy storage and/or power delivery described with reference to FIG. 7 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to the grid 308. The wind farm 302 may generate power and the wind farm 302 may output generated power to the LODES system 304 and/or the transmission facilities 306. The LODES system 304 may store power received from the wind farm 302 and/or the transmission facilities 306. The LODES system 304 may output stored power to the transmission facilities 306. The transmission facilities 306 may output power received from one or both of the wind farm 302 and LODES system 304 to the grid 308 and/or may receive power from the grid 308 and output that power to the LODES system 304. Together the wind farm 302, the LODES system 304, and the transmission facilities 306 may constitute a power plant 350 that may be a combined power generation, transmission, and storage system. The power generated by the wind farm 302 may be directly fed to the grid 308 through the transmission facilities 306, or may be first stored in the LODES system 304. In certain cases the power supplied to the grid 308 may come entirely from the wind farm 302, entirely from the LODES system 304, or from a combination of the wind farm 302 and the LODES system 304. The dispatch of power from the combined wind farm 302 and LODES system 304 power plant 350 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 350, the LODES system 304 may be used to reshape and “firm” the power produced by the wind farm 302. In one such example, the wind farm 302 may have a peak generation output (capacity) of 260 megawatts (MW) and a capacity factor (CF) of 41%. The LODES system 304 may have a power rating (capacity) of 106 MW, a rated duration (energy/power ratio) of 150 hours (h), and an energy rating of 15,900 megawatt hours (MWh). In another such example, the wind farm 302 may have a peak generation output (capacity) of 300 MW and a capacity factor (CF) of 41%. The LODES system 304 may have a power rating of 106 MW, a rated duration (energy/power ratio) of 200 h and an energy rating of 21,200 MWh. In another such example, the wind farm 302 may have a peak generation output (capacity) of 176 MW and a capacity factor (CF) of 53%. The LODES system 304 may have a power rating (capacity) of 88 MW, a rated duration (energy/power ratio) of 150 h and an energy rating of 13,200 MWh. In another such example, the wind farm 302 may have a peak generation output (capacity) of 277 MW and a capacity factor (CF) of 41%. The LODES system 304 may have a power rating (capacity) of 97 MW, a rated duration (energy/power ratio) of 50 h and an energy rating of 4,850 MWh. In another such example, the wind farm 302 may have a peak generation output (capacity) of 315 MW and a capacity factor (CF) of 41%. The LODES system 304 may have a power rating (capacity) of 110 MW, a rated duration (energy/power ratio) of 25 h and an energy rating of 2,750 MWh.

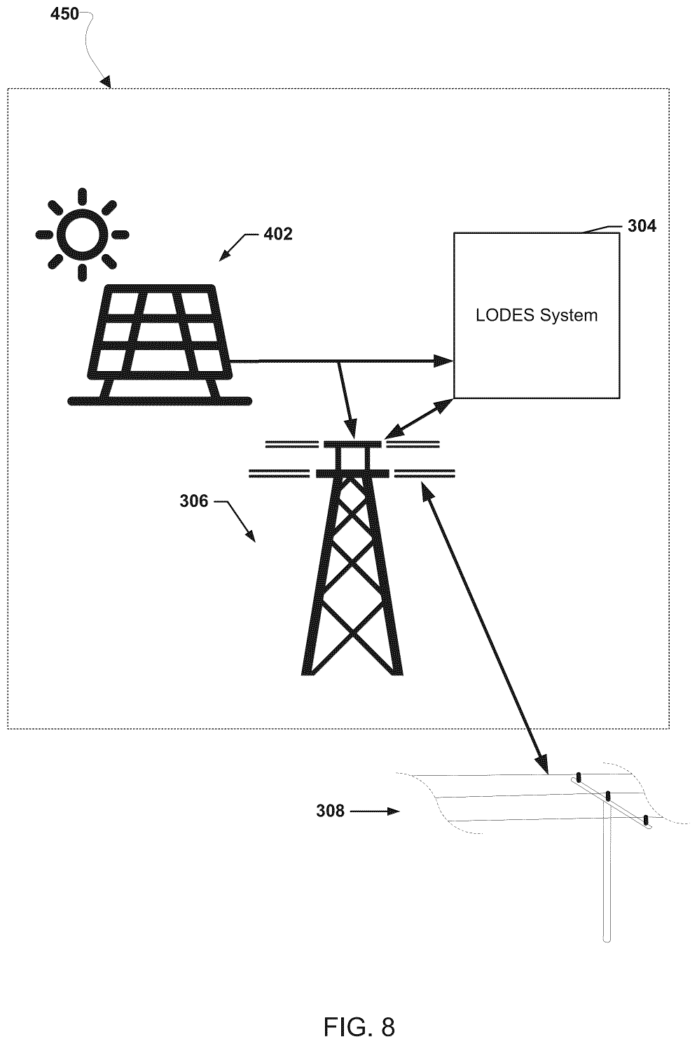

FIG. 8 illustrates an example system in which one or more aspects of the various embodiments may be used as part of bulk energy storage system. While FIG. 8 is discussed in relation to an example LODES system 304, the durations of energy storage and/or power delivery described with reference to FIG. 8 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The system of FIG. 8 may be similar to the system of FIG. 7, except a photovoltaic (PV) farm 402 may be substituted for the wind farm 302. The LODES system 304 may be electrically connected to the PV farm 402 and one or more transmission facilities 306. The PV farm 402 may be electrically connected to the transmission facilities 306. The transmission facilities 306 may be electrically connected to the grid 308. The PV farm 402 may generate power and the PV farm 402 may output generated power to the LODES system 304 and/or the transmission facilities 306. The LODES system 304 may store power received from the PV farm 402 and/or the transmission facilities 306. The LODES system 304 may output stored power to the transmission facilities 306. The transmission facilities 306 may output power received from one or both of the PV farm 402 and LODES system 304 to the grid 308 and/or may receive power from the grid 308 and output that power to the LODES system 304. Together the PV farm 402, the LODES system 304, and the transmission facilities 306 may constitute a power plant 450 that may be a combined power generation, transmission, and storage system. The power generated by the PV farm 402 may be directly fed to the grid 308 through the transmission facilities 306, or may be first stored in the LODES system 304. In certain cases the power supplied to the grid 308 may come entirely from the PV farm 402, entirely from the LODES system 304, or from a combination of the PV farm 402 and the LODES system 304. The dispatch of power from the combined PV farm 402 and LODES system 304 power plant 450 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 450, the LODES system 304 may be used to reshape and “firm” the power produced by the PV farm 402. In one such example, the PV farm 402 may have a peak generation output (capacity) of 490 MW and a capacity factor (CF) of 24%. The LODES system 304 may have a power rating (capacity) of 340 MW, a rated duration (energy/power ratio) of 150 h and an energy rating of 51,000 MWh. In another such example, the PV farm 402 may have a peak generation output (capacity) of 680 MW and a capacity factor (CF) of 24%. The LODES system 304 may have a power rating (capacity) of 410 MW, a rated duration (energy/power ratio) of 200 h, and an energy rating of 82,000 MWh. In another such example, the PV farm 402 may have a peak generation output (capacity) of 330 MW and a capacity factor (CF) of 31%. The LODES system 304 may have a power rating (capacity) of 215 MW, a rated duration (energy/power ratio) of 150 h, and an energy rating of 32,250 MWh. In another such example, the PV farm 402 may have a peak generation output (capacity) of 510 MW and a capacity factor (CF) of 24%. The LODES system 304 may have a power rating (capacity) of 380 MW, a rated duration (energy/power ratio) of 50 h, and an energy rating of 19,000 MWh. In another such example, the PV farm 402 may have a peak generation output (capacity) of 630 MW and a capacity factor (CF) of 24%. The LODES system 304 may have a power rating (capacity) of 380 MW, a rated duration (energy/power ratio) of 25 h, and an energy rating of 9,500 MWh.

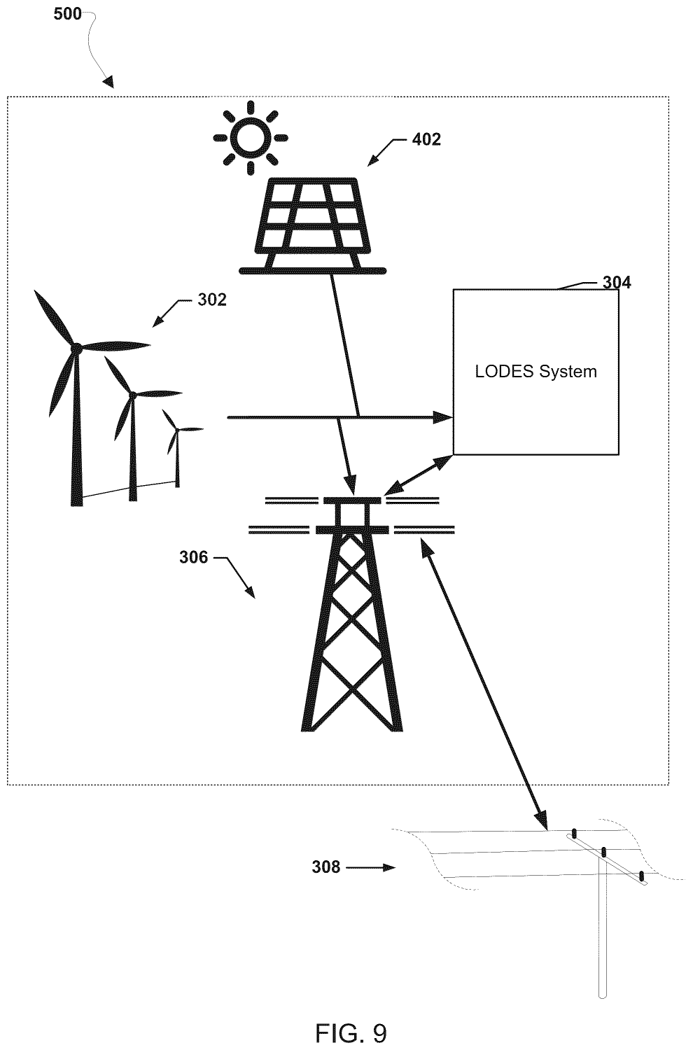

FIG. 9 illustrates an example system in which one or more aspects of the various embodiments may be used as part of bulk energy storage system. While FIG. 9 is discussed in relation to an example LODES system 304, the durations of energy storage and/or power delivery described with reference to FIG. 9 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The system of FIG. 9 may be similar to the systems of FIGS. 7 and 8, except the wind farm 302 and the photovoltaic (PV) farm 402 may both be power generators working together in the power plant 500. Together the PV farm 402, wind farm 302, the LODES system 304, and the transmission facilities 306 may constitute the power plant 500 that may be a combined power generation, transmission, and storage system. The power generated by the PV farm 402 and/or the wind farm 302 may be directly fed to the grid 308 through the transmission facilities 306, or may be first stored in the LODES system 304. In certain cases the power supplied to the grid 308 may come entirely from the PV farm 402, entirely from the wind farm 302, entirely from the LODES system 304, or from a combination of the PV farm 402, the wind farm 302, and the LODES system 304. The dispatch of power from the combined wind farm 302, PV farm 402, and LODES system 304 power plant 500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 500, the LODES system 304 may be used to reshape and “firm” the power produced by the wind farm 302 and the PV farm 402. In one such example, the wind farm 302 may have a peak generation output (capacity) of 126 MW and a capacity factor (CF) of 41% and the PV farm 402 may have a peak generation output (capacity) of 126 MW and a capacity factor (CF) of 24%. The LODES system 304 may have a power rating (capacity) of 63 MW, a rated duration (energy/power ratio) of 150 h, and an energy rating of 9,450 MWh. In another such example, the wind farm 302 may have a peak generation output (capacity) of 170 MW and a capacity factor (CF) of 41% and the PV farm 402 may have a peak generation output (capacity) of 110 MW and a capacity factor (CF) of 24%. The LODES system 304 may have a power rating (capacity) of 57 MW, a rated duration (energy/power ratio) of 200 h, and an energy rating of 11,400 MWh. In another such example, the wind farm 302 may have a peak generation output (capacity) of 105 MW and a capacity factor (CF) of 51% and the PV farm 402 may have a peak generation output (capacity) of 70 MW and a capacity factor (CF) of 31 The LODES system 304 may have a power rating (capacity) of 61 MW, a rated duration (energy/power ratio) of 150 h, and an energy rating of 9,150 MWh. In another such example, the wind farm 302 may have a peak generation output (capacity) of 135 MW and a capacity factor (CF) of 41% and the PV farm 402 may have a peak generation output (capacity) of 90 MW and a capacity factor (CF) of 24%. The LODES system 304 may have a power rating (capacity) of 68 MW, a rated duration (energy/power ratio) of 50 h, and an energy rating of 3,400 MWh. In another such example, the wind farm 302 may have a peak generation output (capacity) of 144 MW and a capacity factor (CF) of 41% and the PV farm 402 may have a peak generation output (capacity) of 96 MW and a capacity factor (CF) of 24%. The LODES system 304 may have a power rating (capacity) of 72 MW, a rated duration (energy/power ratio) of 25 h, and an energy rating of 1,800 MWh.

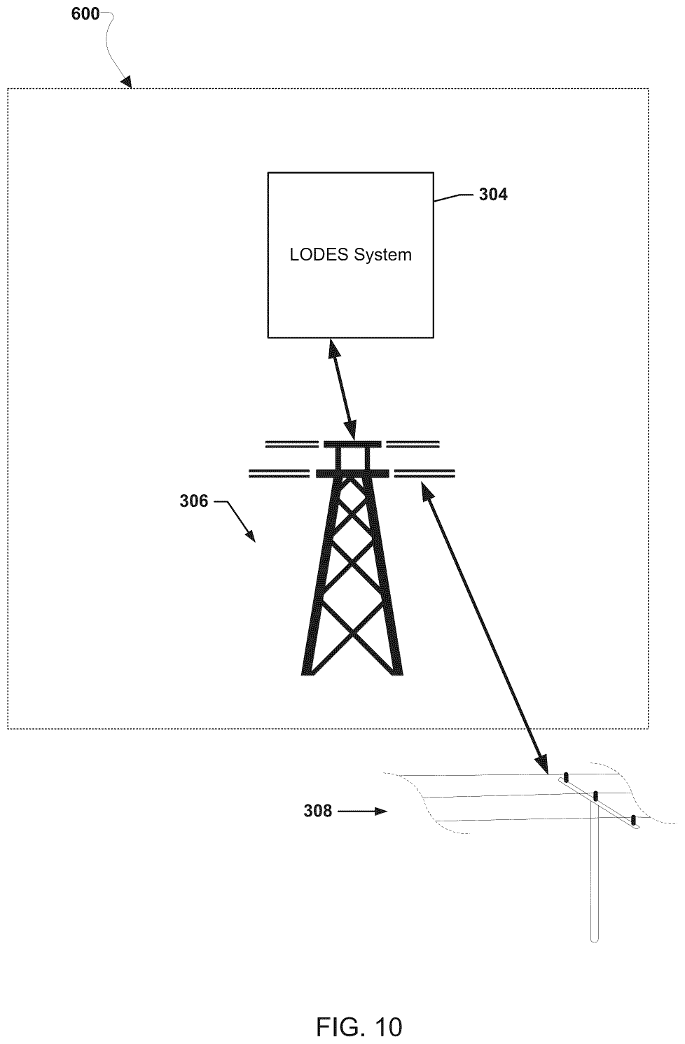

FIG. 10 illustrates an example system in which one or more aspects of the various embodiments may be used as part of bulk energy storage system. While FIG. 10 is discussed in relation to an example LODES system 304, the durations of energy storage and/or power delivery described with reference to FIG. 10 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to one or more transmission facilities 306. In this manner, the LODES system 304 may operate in a “stand-alone” manner to arbiter energy around market prices and/or to avoid transmission constraints. The LODES system 304 may be electrically connected to one or more transmission facilities 306. The transmission facilities 306 may be electrically connected to the grid 308. The LODES system 304 may store power received from the transmission facilities 306. The LODES system 304 may output stored power to the transmission facilities 306. The transmission facilities 306 may output power received from the LODES system 304 to the grid 308 and/or may receive power from the grid 308 and output that power to the LODES system 304.

Together the LODES system 304 and the transmission facilities 306 may constitute a power plant 600. As an example, the power plant 600 may be situated downstream of a transmission constraint, close to electrical consumption. In such an example downstream situated power plant 600, the LODES system 304 may have a duration of 24 h to 500 h and may undergo one or more full discharges a year to support peak electrical consumptions at times when the transmission capacity is not sufficient to serve customers. Additionally in such an example downstream situated power plant 600, the LODES system 304 may undergo several shallow discharges (daily or at higher frequency) to arbiter the difference between nighttime and daytime electricity prices and reduce the overall cost of electrical service to customer. As a further example, the power plant 600 may be situated upstream of a transmission constraint, close to electrical generation. In such an example upstream situated power plant 600, the LODES system 304 may have a duration of 24 h to 500 h and may undergo one or more full charges a year to absorb excess generation at times when the transmission capacity is not sufficient to distribute the electricity to customers. Additionally in such an example upstream situated power plant 600, the LODES system 304 may undergo several shallow charges and discharges (daily or at higher frequency) to arbiter the difference between nighttime and daytime electricity prices and maximize the value of the output of the generation facilities.

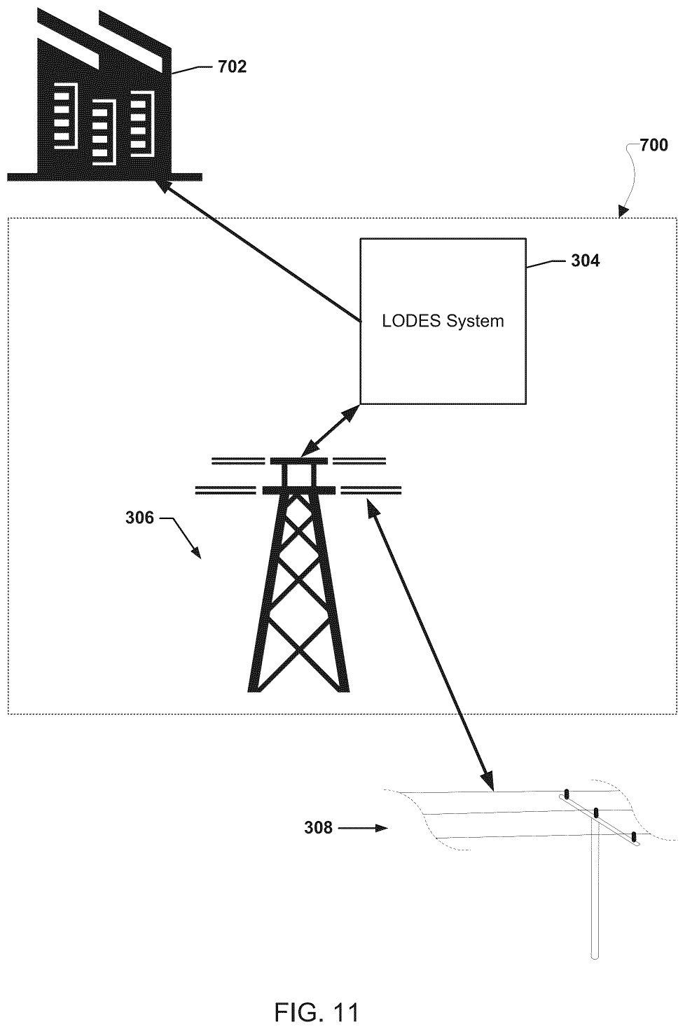

FIG. 11 illustrates an example system in which one or more aspects of the various embodiments may be used as part of bulk energy storage system. While FIG. 11 is discussed in relation to an example LODES system 304, the durations of energy storage and/or power delivery described with reference to FIG. 11 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a commercial and industrial (C&I) customer 702, such as a data center, factory, etc. The LODES system 304 may be electrically connected to one or more transmission facilities 306. The transmission facilities 306 may be electrically connected to the grid 308. The transmission facilities 306 may receive power from the grid 308 and output that power to the LODES system 304. The LODES system 304 may store power received from the transmission facilities 306. The LODES system 304 may output stored power to the C&I customer 702. In this manner, the LODES system 304 may operate to reshape electricity purchased from the grid 308 to match the consumption pattern of the C&I customer 702.

Together, the LODES system 304 and transmission facilities 306 may constitute a power plant 700. As an example, the power plant 700 may be situated close to electrical consumption, i.e., close to the C&I customer 702, such as between the grid 308 and the C&I customer 702. In such an example, the LODES system 304 may have a duration of 24 h to 500 h and may buy electricity from the markets and thereby charge the LODES system 304 at times when the electricity is cheaper. The LODES system 304 may then discharge to provide the C&I customer 702 with electricity at times when the market price is expensive, therefore offsetting the market purchases of the C&I customer 702. As an alternative configuration, rather than being situated between the grid 308 and the C&I customer 702, the power plant 700 may be situated between a renewable source, such as a PV farm, wind farm, etc., and the transmission facilities 306 may connect to the renewable source. In such an alternative example, the LODES system 304 may have a duration of 24 h to 500 h, and the LODES system 304 may charge at times when renewable output may be available. The LODES system 304 may then discharge to provide the C&I customer 702 with renewable generated electricity so as to cover a portion, or the entirety, of the C&I customer 702 electricity needs.

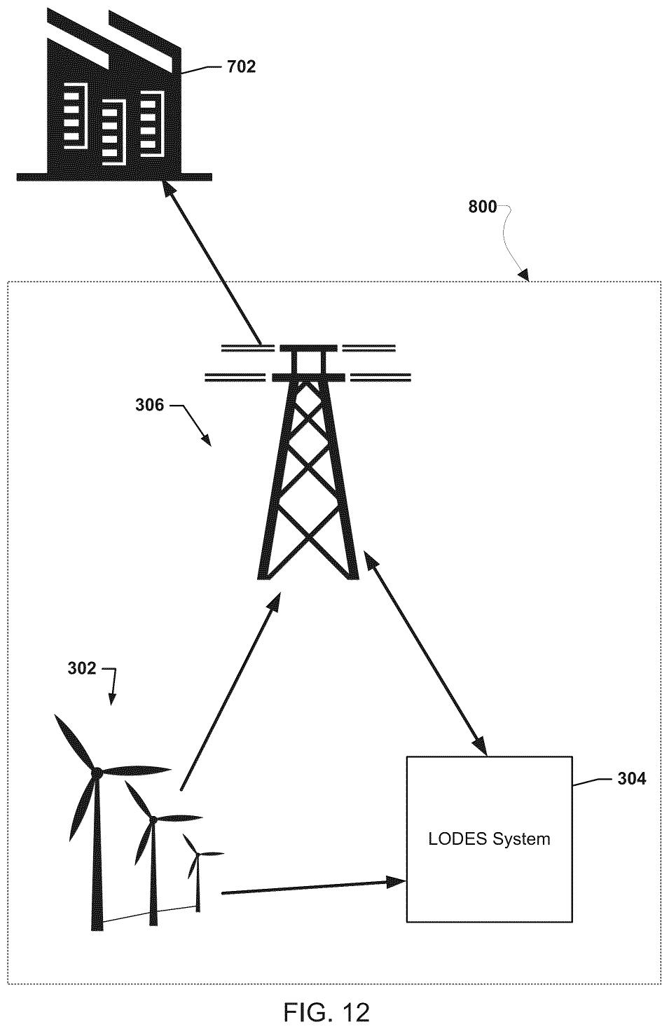

FIG. 12 illustrates an example system in which one or more aspects of the various embodiments may be used as part of bulk energy storage system. While FIG. 12 is discussed in relation to an example LODES system 304, the durations of energy storage and/or power delivery described with reference to FIG. 12 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to a C&I customer 702. The wind farm 302 may generate power and the wind farm 302 may output generated power to the LODES system 304 and/or the transmission facilities 306. The LODES system 304 may store power received from the wind farm 302.

The LODES system 304 may output stored power to the transmission facilities 306. The transmission facilities 306 may output power received from one or both of the wind farm 302 and LODES system 304 to the C&I customer 702. Together the wind farm 302, the LODES system 304, and the transmission facilities 306 may constitute a power plant 800 that may be a combined power generation, transmission, and storage system. The power generated by the wind farm 302 may be directly fed to the C&I customer 702 through the transmission facilities 306, or may be first stored in the LODES system 304. In certain cases, the power supplied to the C&I customer 702 may come entirely from the wind farm 302, entirely from the LODES system 304, or from a combination of the wind farm 302 and the LODES system 304. The LODES system 304 may be used to reshape the electricity generated by the wind farm 302 to match the consumption pattern of the C&I customer 702. In one such example, the LODES system 304 may have a duration of 24 h to 500 h and may charge when renewable generation by the wind farm 302 exceeds the C&I customer 702 load. The LODES system 304 may then discharge when renewable generation by the wind farm 302 falls short of C&I customer 702 load so as to provide the C&I customer 702 with a firm renewable profile that offsets a fraction, or all of, the C&I customer 702 electrical consumption.

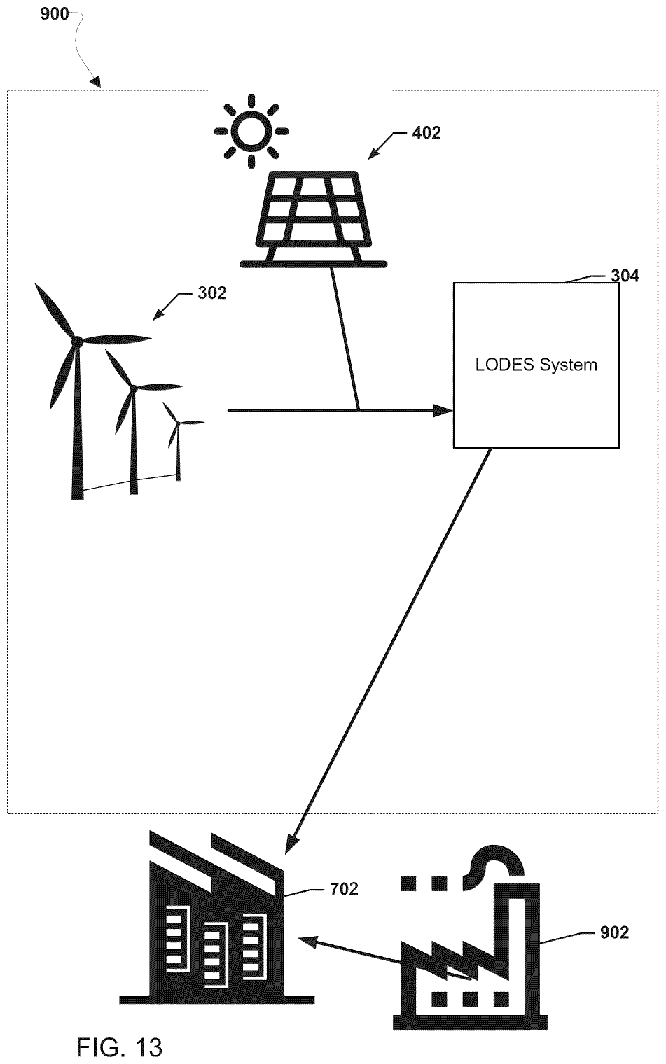

FIG. 13 illustrates an example system in which one or more aspects of the various embodiments may be used as part of bulk energy storage system. While FIG. 13 is discussed in relation to an example LODES system 304, the durations of energy storage and/or power delivery described with reference to FIG. 13 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be part of a power plant 900 that is used to integrate large amounts of renewable generation in microgrids and harmonize the output of renewable generation by, for example a PV farm 402 and wind farm 302, with existing thermal generation by, for example a thermal power plant 902 (e.g., a gas plant, a coal plant, a diesel generator set, etc., or a combination of thermal generation methods), while renewable generation and thermal generation supply the C&I customer 702 load at high availability. Microgrids, such as the microgrid constituted by the power plant 900 and the thermal power plant 902, may provide availability that is 90% or higher. The power generated by the PV farm 402 and/or the wind farm 302 may be directly fed to the C&I customer 702, or may be first stored in the LODES system 304.

In certain cases the power supplied to the C&I customer 702 may come entirely from the PV farm 402, entirely from the wind farm 302, entirely from the LODES system 304, entirely from the thermal power plant 902, or from any combination of the PV farm 402, the wind farm 302, the LODES system 304, and/or the thermal power plant 902. As examples, the LODES system 304 of the power plant 900 may have a duration of 24 h to 500 h. As a specific example, the C&I customer 702 load may have a peak of 100 MW, the LODES system 304 may have a power rating of 14 MW and duration of 150 h, natural gas may cost $6/million British thermal units (MMBTU), and the renewable penetration may be 58%. As another specific example, the C&I customer 702 load may have a peak of 100 MW, the LODES system 304 may have a power rating of 25 MW and duration of 150 h, natural gas may cost $8/MMBTU, and the renewable penetration may be 65%.

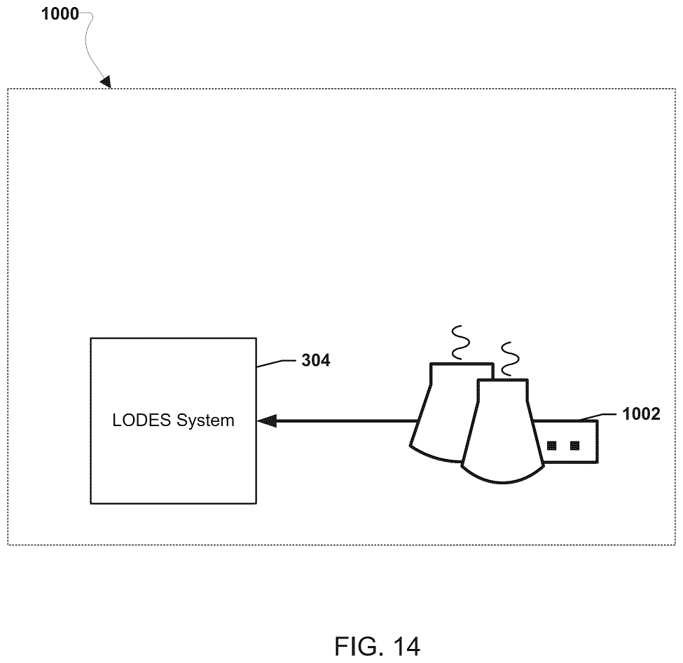

FIG. 14 illustrates an example system in which one or more aspects of the various embodiments may be used as part of bulk energy storage system. While FIG. 14 is discussed in relation to an example LODES system 304, the durations of energy storage and/or power delivery described with reference to FIG. 14 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be used to augment a nuclear plant 1002 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 1000 constituted by the combined LODES system 304 and nuclear plant 1002. The nuclear plant 1002 may operate at high capacity factor and at the highest efficiency point, while the LODES system 304 may charge and discharge to effectively reshape the output of the nuclear plant 1002 to match a customer electrical consumption and/or a market price of electricity. As examples, the LODES system 304 of the power plant 1000 may have a duration of 24 h to 500 h. In one specific example, the nuclear plant 1002 may have 1,000 MW of rated output and the nuclear plant 1002 may be forced into prolonged periods of minimum stable generation or even shutdowns because of depressed market pricing of electricity. The LODES system 304 may avoid facility shutdowns and charge at times of depressed market pricing; and the LODES system 304 may subsequently discharge and boost total output generation at times of inflated market pricing.

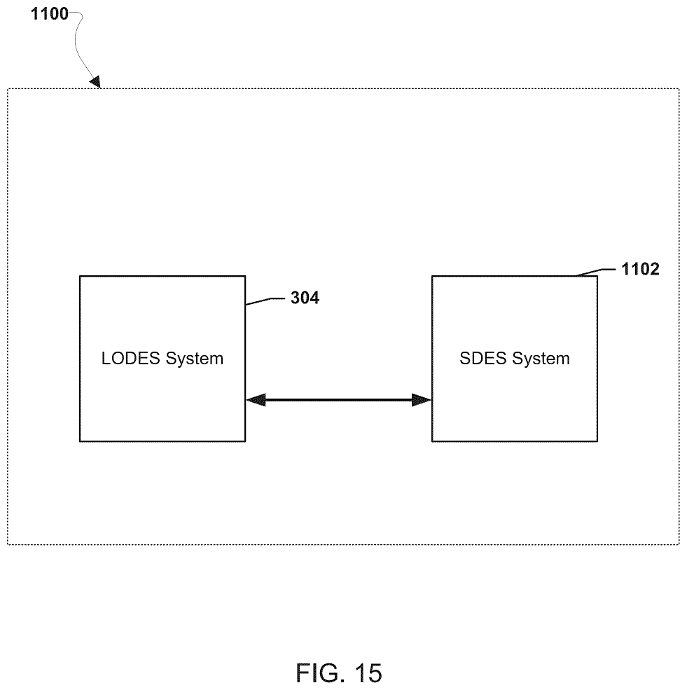

FIG. 15 illustrates an example system in which one or more aspects of the various embodiments may be used as part of bulk energy storage system. While FIG. 15 is discussed in relation to an example LODES system 304 and SDES system 1102, the durations of energy storage and/or power delivery described with reference to FIG. 15 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may operate in tandem with a SDES system 1102. Together the LODES system 304 and SDES system 1102 may constitute a power plant 1100. As an example, the LODES system 304 and SDES system 1102 may be co-optimized whereby the LODES system 304 may provide various services, including long-duration back-up and/or bridging through multi-day fluctuations (e.g., multi-day fluctuations in market pricing, renewable generation, electrical consumption, etc.), and the SDES system 1102 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 1102 may have durations of less than 10 hours and round-trip efficiencies of greater than 80%. The LODES system 304 may have durations of 24 h to 500 h and round-trip efficiencies of greater than 40%. In one such example, the LODES system 304 may have a duration of 150 hours and support customer electrical consumption for up to a week of renewable under-generation. The LODES system 304 may also support customer electrical consumption during intra-day under-generation events, augmenting the capabilities of the SDES system 1102. Further, the SDES system 1102 may supply customers during intra-day under-generation events and provide power conditioning and quality services such as voltage control and frequency regulation.

Having described above certain aspects of energy storage systems, devices, and components including aqueous oxyanion electrolytes, attention is now specifically directed to description of aspects of halogen oxyanion-based electrodes and related batteries and systems. For the sake of clear and efficient description, aspects of the energy storage systems, devices, and components described above are not necessarily repeated in the description of halogen oxyanion-based electrodes and related batteries and systems described below. However, unless otherwise specified or made clear from the context, it shall be understood that various aspects of the energy storage systems, devices, and components described above may be combined with the halogen oxyanion-based electrodes and related batteries and systems described below. For example, unless a contrary intent is explicitly indicated or is clear from the context, any one or more of the various, different halogen oxyanion-based electrodes and related batteries and systems described below may be uses as part of bulk energy storage systems, such as LODES systems, SDES systems, systems needing power delivery for any time period, etc., such as the examples described above with respect to FIGS. 7-15

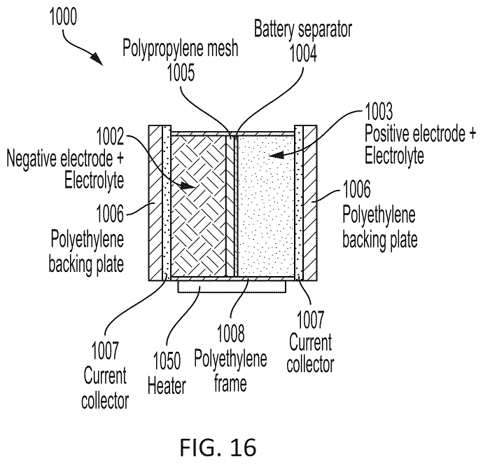

In some embodiments, an electrochemical cell includes a negative electrode, a positive electrode, an electrolyte, and a separator disposed between the positive electrode and the negative electrode (for example as shown in FIG. 16). FIG. 16 illustrates an example electrochemical cell 1000, such as a battery, including a negative electrode and electrolyte 1002 separated from a positive electrode and electrolyte 1003 by a separator 1004. The separator 1004 may be supported by a polypropylene mesh 1005 and a polyethylene frame 1008 of the electrochemical cell 1000. Current collectors 1007 may be associated with respective ones of the negative electrode 1002 and positive electrode 1003 and supported by polyethylene backing plates 1006. In some embodiments, the temperature of the electrochemical cell 1000, may be controlled, such as by insulation around the electrochemical cell 1000 and/or a heater 1050. For example, the heater 1050 may raise the temperature of the electrochemical cell 1000 and/or specific components of the cell, such as the electrolyte 1002, 1003. The configuration of the electrochemical cell 1000 in FIG. 16 is merely an example of one electrochemical cell configuration according to various embodiments and is not intended to be limiting. Other configurations, such as electrochemical cells with different type meshes and/or without the polypropylene mesh 1005, electrochemical cells with different type frames and/or without the polyethylene frame 1008, electrochemical cells with different type current collectors and/or without the current collectors, electrochemical cells with different type backing plates and/or without the polyethylene backing plates 1006, electrochemical cells with different type insulation and/or without insulation, and/or electrochemical cells with different type heaters and/or without a heater 1050, may be substituted for the example configuration of the electrochemical cell 1000 shown in FIG. 16 and other configurations are in accordance with the various embodiments.

In some embodiments, a plurality of electrochemical cells (or batteries) 1000 in FIG. 16 may be connected electrically in series to form a stack. In certain other embodiments, a plurality of electrochemical cells 1000 may be connected electrically in parallel. In certain other embodiments, the electrochemical cells 1000 are connected in a mixed series-parallel electrical configuration to achieve a favorable combination of delivered current and voltage.

Various embodiments include halogen oxyanion based electrodes and related batteries and systems. Various embodiments include electrochemical electrode reactions comprising halogen oxyanions. Various embodiments may include an electrode in an electrochemical device comprising an electrode reaction, or redox reaction, of a halogenated oxyanion species.

Various embodiments include reversible Cl(III)/Cl(IV) electrodes, processes for making reversible Cl(III)/Cl(IV) electrodes, and batteries and battery systems including reversible Cl(III)/Cl(IV) electrodes. Various embodiments may include a direct reversible Cl(III)/Cl(IV) cathode, for example coupled with ClO₂ storage, in a battery and/or battery system. Various embodiments may include an indirect Cl(III)/Cl(IV) electrode, for example without ClO₂ storage, in a battery and/or battery system. Such indirect Cl(III)/Cl(IV) electrode may be, for example, based on a 3-Chemical Chlorine Dioxide Reaction.

A first example implementation may include an alkaline electrolyte with a polysulfide electrode and NaClO₂ electrode. Such an example has been observed to have an open circuit voltage (OCV) of 1.50 volts (V). A second example implementation may include an alkaline electrolyte with an iron electrode and NaClO₂ electrode. Such an example is calculated to have an OCV of 1.84V. A third example implementation may include a neutral electrolyte with an iron electrode and NaClO₂ electrode. Such an example is calculated to have an OCV of 1.39V. A fourth example implementation may include an acidic electrolyte with a hydrogen electrode and NaClO₂ electrode. Such an example is calculated to have an OCV of 1.27V.

Various embodiments may include an electrode in an electrochemical device comprising an electrode reaction, or redox reaction, of a halogenated oxyanion species. Various embodiments may include certain chemical species involved in said redox reactions, one or more of which may be a halogenated oxyanion. The reactant or product of said redox reaction may comprise an ionic or electrically neutral chemical species. In some embodiments, the electrochemical device is a storage battery, which may include batteries of the primary type, which is understood to mean that the battery is provided in a charged or partially charged state and discharged once, or may be batteries of secondary type, which is understood to mean rechargeable batteries which may be recharged or partially recharged at least once before being discharged again. In some embodiments, said redox reaction may comprise oxidation of said halogenated oxyanion species. In other embodiments, said redox reaction may comprise reduction of said halogenated oxyanion species. In some embodiments, said redox reaction may comprise the reversible oxidation and reduction of said chemical species. In various embodiments, the current collector at which said redox reaction occurs may be selected to allow such highly reversible reaction, by which it is meant that the overpotential for oxidation or reduction is relatively small. Such current collectors may comprise various metals or metal compounds as described herein, and preferably, may comprise carbon. Said electrode may comprise the positive electrode or the negative electrode of said electrochemical device. In some embodiments, the halogen may be chlorine or bromine.

In addition to chemical compositions used in said redox reactions, electrodes, and electrochemical devices, various embodiments may include materials used in said electrochemical devices, the design of said devices, and systems and methods of use of said devices and systems.

An example of the redox reactions of the various embodiments is the electrochemical reaction between chlorine (III) oxyanion (ClO2-) and chlorine (IV) dioxide (ClO2), which in some embodiments may be carried out in an aqueous electrolyte. The chlorine (III) oxyanion (i.e., chlorite containing compound) may be provided in the form of a chlorite salt, including but not limited to HClO₂, LiClO₂, NaClO₂, KClO₂, RbClO₂, and CsClO₂, which may dissociate at least partially in the electrolyte used. Such reversible halogenated oxyanion electrodes may be operated in acidic, neutral, or alkaline aqueous electrolytes.

In acidic electrolyte, the electrode half-cell reaction may be:

ClO₂+H⁺+e⁻⇔HClO₂E⁰=1.277VvsSHE (Eq. 1)

In neutral or alkaline electrolyte, the electrode half-cell reaction may be:

ClO₂(aq)+e⁻⇔ClO₂⁻E⁰=0.954VvsSHE (Eq. 2)

The solubility of NaClO₂ in water is substantial, being:

8.4mol_NaClO₂/L_H₂O at 25degC; and 4.3mol_NaClO₂/L_H₂O at 17degC.

Accordingly, in use as an electrochemical battery, an aqueous electrolyte may have a substantial concentration of ClO₂ or HClO₂, resulting in a desirably high storage capacity or energy density.

According to the above electrode half-cell reactions, ClO₂, chlorine dioxide, may be the product of the oxidation reaction. The solubility of ClO₂ in water is relatively low, being 0.12 mol_ClO₂/L_H₂O at 20 degC. The boiling point of ClO₂ at 1 atmosphere pressure is about 11 degC, and said boiling point increases with the applied pressure. The freezing point of ClO₂ is about −68 degC. In some embodiments, at least a portion of the chlorine dioxide produced by electrochemical oxidation is present within or as a phase separate and distinct from the aqueous electrolyte. Said phase may be a liquid phase, or a solid phase. In some embodiments, the operating temperature of the battery is low enough, and the pressure to which the reactants are subjected is high enough, so that at least some of the chlorine dioxide produced is present as a separate phase. In some embodiments, the electrochemical device is sealed, and is under internal pressure during at least some of its state-of-charge range.

In some embodiments, the current collector for the reversible Cl(III)/Cl(IV) electrode comprises a carbon-based material, a metal or metal alloy, or an electronically conductive compound. Said carbon-based material may comprise glassy carbon, disordered carbon, graphite, carbon black, activated carbon, carbon fiber, carbon nanotubes, heteroatom doped carbon nanotube, graphene, heteroatom doped graphene, graphene oxide, or other carbonaceous material. In certain embodiments, the carbon-based current collector comprises the form of a carbon plate, carbon felt, carbon foam, reticulated carbon, carbon cloth, carbon paper, or other form. Said metal or metal alloy may comprise iron, carbon steel, stainless steel, titanium, nickel, copper, silver, platinum, palladium, or other metal. Said electronically conductive compounds may comprise metal carbides, metal sulfides, metal nitrides, metal oxides, or alloys of such compounds.

In certain embodiments, the reversible Cl(III)/Cl(IV) electrode contains oxygen evolution inhibitors or suppressants. In certain embodiments, the reversible Cl(III)/Cl(IV) electrode contains electrocatalysts including but not limited to, noble metals and alloys, noble metal oxides, transition metals and alloys, transition metal oxides, and the like. In certain embodiments, the reversible Cl(III)/Cl(IV) electrode is a gas diffusion electrode containing hydrophobic polymers such as PTFE, FEP, polyethylene, polypropylene, or a combination thereof.

In some embodiments, the current collector is in the form of solid plate, perforated plate, felt, foam, wool, mesh, or other form. In some embodiments, the current collector is a conductive substrate coated by one or more of the preceding electrode or catalyst materials.

Reversible Cl(III)/Cl(IV) Electrode

The oxidation reaction from chlorite (ClO2-) to chlorine dioxide (ClO2), and the reduction reaction back to chlorite, is surprisingly found to be highly reversible with low overpotential in either direction, and in acidic or alkaline electrolyte, as shown in the following examples.

### Example 1: Cl(III)/Cl(IV) Redox Reaction in Alkaline Solution

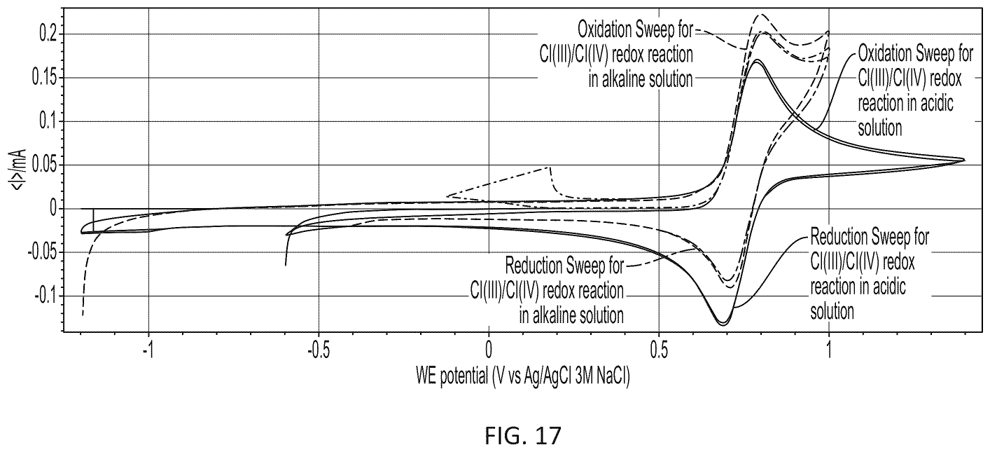

Three-electrode cyclic voltammetry was conducted at room temperature (about 23° C. in this context) using a glassy carbon working electrode, a platinum counter electrode, and an Ag/AgCl reference electrode (3M NaCl). The electrolyte contained 10 mM NaClO₂ dissolved in reverse osmosis deionized (RODI) water, and 1M KOH, producing pH≈14. A polypropylene laboratory cell was used. The working electrode potential was swept from −1.2V to 1.0V (with respect to Ag/AgCl) at a rate of 100 mV/sec and the current was recorded. An example of the results is shown in FIG. 17. A peak centered at about 0.8V is observed during the oxidation sweep (from low to high potential), while a peak centered at about 0.7V is observed during the reduction sweep.

### Example 2: Cl(III)/Cl(IV) Redox Reaction in Acidic Solution

Three-electrode cyclic voltammetry was conducted at room temperature (about 23° C. in this context) using a glassy carbon working electrode, a platinum counter electrode, and an Ag/AgCl reference electrode (3M NaCl). The electrolyte contained 10 mM NaClO₂ dissolved in reverse osmosis deionized (RODI) water, and 9 mM H₂SO₄, producing pH 2. A polypropylene laboratory cell was used. The working electrode potential was swept from −0.6V to 1.4V (with respect to Ag/AgCl) at a rate of 100 mV/sec and the current was recorded. An example of the results is shown in FIG. 17. A peak centered at about 0.8V is observed during the oxidation sweep (from low to high potential), while a peak centered at about 0.7V is observed during the reduction sweep.

Thus, as may be appreciated from the results of Example 1 and Example 2 above, the Cl(III)/Cl(IV) redox reaction is shown to be highly reversible in both acidic and alkaline solution.

Direct Reversible Cl(III)/Cl(IV) Electrode (with ClO₂ Storage)

Depending on the temperature and pressure, chlorine dioxide can be stored in the form of a gas, liquid, liquid solution, solid, or a combination thereof. A chlorite bearing compound, including for example NaClO₂, NaBrO₂, KClO₂, or KBrO₂, may be stored as a dissolved solution. In some embodiments, the chlorite bearing compound and chlorine dioxide may be stored in the same enclosure. In some embodiments, the chlorite containing compound and chlorine dioxide may each be stored in separate enclosure. In certain embodiments, chlorine dioxide may be stored at a temperature ≤11° C. In certain embodiments, the reversible Cl(III)/Cl(IV) electrode may include a chlorite stabilizer. In certain embodiments, the reversible Cl(III)/Cl(IV) electrode may contain a chlorine dioxide stabilizer. Such stabilizers may reduce or eliminate decomposition of chlorine dioxide to other compounds, or decrease the self-discharge rate of the battery. In certain embodiments, the reversible Cl(III)/Cl(IV) electrode may be used in a tank cell configuration where the active species are contained within the cell embodiment. In certain embodiments, the reversible Cl(III)/Cl(IV) electrode may be in a flow cell configuration where the active species are pumped to the cell from an external storage vessel. In some embodiments as a storage battery, during charge, Cl(III) is oxidized to Cl(IV), and the electrical energy is stored in the form of chlorine dioxide. During discharge, Cl(IV) is reduced to Cl(III), and the electrical energy is released to the external circuit.

An Iron-Chlorine Dioxide Battery

A Cl(III)/Cl(IV) electrode, such as any one or more of the Cl(III)/Cl(IV) electrode described above, may be used as a reversible electrode. As described in greater detail below, embodiments of the reversible Cl(III)/Cl(IV) electrode include: direct reversible Cl(III)/Cl(IV) cathode (with ClO₂ storage) and indirect Cl(III)/Cl(IV) electrode (without ClO₂ storage) (based on 3-Chemical Chlorine Dioxide Reaction).

The above-described Cl(III)/Cl(IV) electrode may be used as a positive electrode in a battery. It may be paired with various negative electrodes, including but not limited to the following combinations: polysulfide negative electrode NaClO₂ alkaline electrolyte battery (OCV=1.50V, empirical); iron negative electrode NaClO₂ alkaline electrolyte battery (OCV=1.84V, calculated); iron negative electrode NaClO₂ neutral electrolyte battery (OCV=1.39V, calculated); hydrogen negative electrode NaClO₂ acidic electrolyte battery (OCV=1.27V, calculated). Several of these examples are described in greater detail below.

More generally, the negative electrode may include a metal or alloy, including but not limited to a first-row transition metal (e.g., titanium, vanadium, chromium, manganese, iron, cobalt, nickel, copper, or zinc), tin, cadmium, lead, magnesium, calcium, aluminum lithium, sodium, potassium, rubidium, or cesium. The negative electrode may have a half-cell reaction, especially in alkaline electrolyte, that comprises the formation of an oxide, hydroxide, or other metal salt during oxidation, corresponding to discharge of the battery. The metal salt may be soluble in the electrolyte in some instances. In other instances, the metal salt may remain in solid form and may be at least partially attached to the metal or alloy. Upon charging, the metal salt may be reduced to a metal or alloy.

The negative electrode may also have, especially in acidic electrolyte, a half-cell reaction comprising dissolution of the metal as metal ions or complexes in the electrolyte upon discharge of said battery. Upon charging, the metal ions or complexes may be reduced to the metal or alloy.

In some embodiments, the negative electrode comprises sulfur. Sulfur negative electrodes may comprise sulfur in any of its oxidation states including elemental sulfur and various polysulfides including S₂⁻, S₂²⁻, S₃²⁻, S₄²⁻, and S₅²⁻. For example, such polysulfides may be prepared by dissolving in aqueous solution any one or more of the compounds Na₂S, Na₂S₂, Na₂S₃, Na₂S₄, or Na₂S₅. The electrolyte may be alkaline, to avoid the formation of H₂S gas. In a particular embodiment, the electrolyte is alkaline and the polysulfide is cycled between the limits S₂²⁻ to S₄²⁻. A battery cell using S₂²⁻/S₄²⁻ as the negative electrode redox reaction and ClO₂⁻/ClO₂ as the positive electrode redox reaction may have an open circuit voltage of about 1.50 V.

In some embodiments, the oxidation or reduction of a positive or negative electrode may be facilitated or assisted by a redox mediator compound.

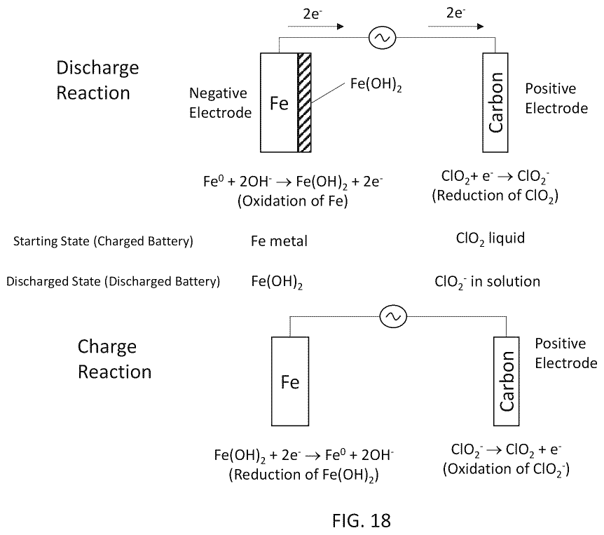

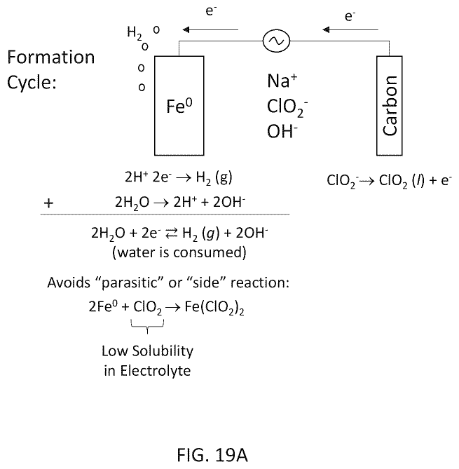

As an example of such a battery, consider an iron-chlorine dioxide battery, the operation of which is shownin FIG. 18. Here, the negative electrode when in the charged state may comprise metallic iron, which may also serve as the negative current collector. The positive current collector may comprise carbon, at which reactions of the positive electrode compounds (e.g., the oxidation of chlorite to chlorine or chlorine dioxide, or reduction of chlorate or chlorine dioxide to chlorite or chloride) may take place. The electrolyte may have an alkaline pH. During discharge, said metallic iron may be oxidized to ferrous iron hydroxide, Fe(OH)₂, ferric iron oxyhydroxide, FeOOH, or one or more ferrous or ferric iron oxides, FeO, Fe₃O₄, or Fe₂O₃. During discharge, at the carbon positive current collector, ClO₂ may be reduced to chlorite ions, ClO₂. As the battery is increasingly discharged, the amount of iron oxidation product may increase, as may the amount of chlorite ions. Said chlorite ions may be partially or completely dissolved in the electrolyte. Upon charging of the battery, the iron hydroxide or oxide or oxyhydroxide may be partially or completely reduced to metallic iron, and the chlorite ions may be oxidized to chlorine dioxide.

Another configuration for an iron-chlorine dioxide battery may comprise an acidic electrolyte of pH<7. In such instances, the oxidation of the iron electrode upon discharge of the battery may comprise its dissolution as ferrous ion: Fe⁰=Fe²⁺+2e⁻. During charging, dissolved iron ions may be reduced at the negative electrode, in the reverse of this reaction.

According to these embodiments, the starting state of the battery may be charged or partially charged, in which case there is at least some metallic iron or an iron alloy at the negative electrode and at least some chlorine dioxide at the positive electrode. This starting state may be achieved by assembling the battery using metallic iron and chlorine dioxide as components. Additionally, or alternatively, the starting state may be achieved by carrying out an initial electrochemical reaction that forms ClO₂ within the cell, regardless of whether the iron-comprising negative electrode undergoes reduction to metallic iron. This initial electrochemical reaction is also herein referred to as “formation” or a “formation cycle” or “formation reaction,” and has the characteristics that a reduction “side reaction” occurs at the negative electrode so that oxidation can occur at the positive electrode. This side reaction may produce a reaction product that is a gas, liquid, or solid, and which may not thereafter substantially participate in the charge-discharge reactions of the battery.

An example of such a formation cycle is shown in FIG. 4, where the initial state of the battery has metallic iron at the negative electrode. Even if there is no oxidized iron salt available to be reduced to metallic iron, ClO₂ may be formed, via oxidation of chlorite at the positive electrode, by charging or “overcharging” the battery such that hydrogen reduction takes place at the negative electrode. The hydrogen reduction may produce hydrogen gas that is released from the battery to the atmosphere such that it is no longer available to participate in a subsequent discharge reaction.

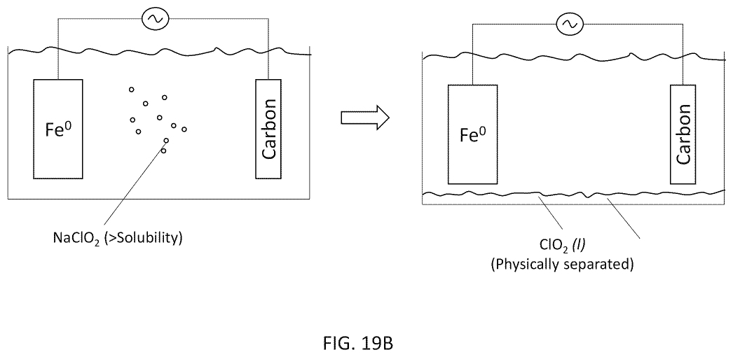

During the formation reaction, a source of chlorite ions is for forming chlorine dioxide may include a chlorite compound, such as an alkali chlorite (e.g., NaClO₂). As shown in FIGS. 19A-19B, the NaClO₂ may be dissolved in the electrolyte, or may be present as a solid immiscible phase, in which instance the electrolyte may be saturated with NaClO₂ or nearly so. The solid NaClO₂ may serve as a reservoir to supply chlorite ions to the electrolyte for oxidation to chlorine dioxide at the positive electrode. As chlorine dioxide is formed, the amount of solid NaClO₂ may be reduced, up to and including the reduction of all NaClO₂ present. As the battery is charged and discharged, the amount of solid NaClO₂ may be negligible if all or most of the NaClO₂ remains dissolved, or may vary as the solubility limit of NaClO₂ in the electrolyte is traversed. That is, solid NaClO₂ may be present at some states of charge of the battery, and may dissolve or precipitate as needed to maintain a saturated or nearly saturated solution of NaClO₂.

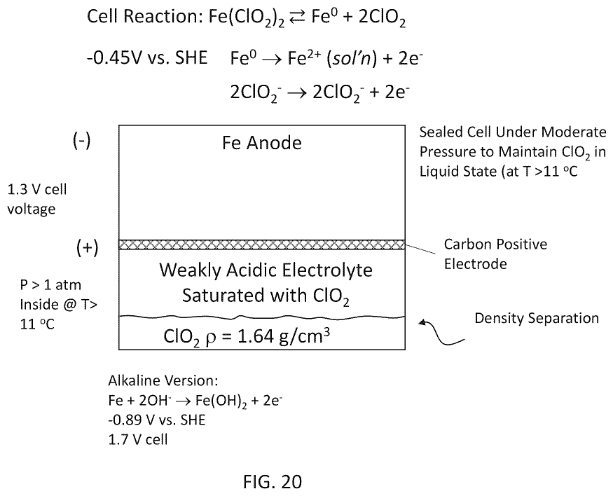

FIG. 20 is a schematic representation of an iron-chlorine dioxide battery. If a weakly acidic electrolyte is used, the equilibrium or open-circuit cell voltage may be about 1.3 V. If an alkaline electrolyte is used, the cell voltage may be about 1.7 V. If a zinc electrode is used instead of an iron electrode, the cell voltage may be still higher, at about 2.0 V. The boiling point of ClO₂ under standard state conditions of 1 atmosphere pressure is about 11° C. Accordingly, ClO₂ produced in the cell may be present as a liquid phase if the temperature is below about 11° C. under 1 atmosphere pressure, or at higher temperatures, including room temperature or higher, under a higher pressure. The higher pressure may be produced by sealing the cell such that, as ClO₂ is produced, the internal pressure of the cell increases.

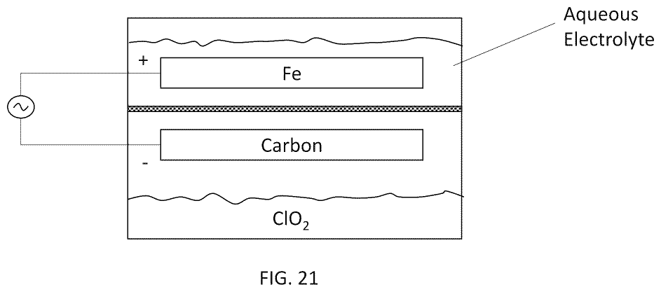

ClO₂ has limited solubility in aqueous solution, and has a density of 1.64 g/cm³ that is higher than that of typical aqueous electrolytes. The density of ClO₂ may also be lower than that of certain electrolytes such as the “water-in-salt” type of electrolyte, wherein there is a higher concentration of the electrolyte salt than the water solvent. Accordingly, as shown in FIGS. 19A, 19B, 20, and 21, the electrochemical cell may allow a chlorine dioxide rich layer (which may be a separate immiscible phase comprising liquid or solid ClO₂ or a layer of electrolyte enriched in ClO₂) to separate(e.g., sinking or floating) from the electrolyte and/or the electrodes under the force of gravity. In some embodiments, at least one electrode has a width-to-length aspect ratio greater than about 2:1, and preferably greater than about 5:1, including electrodes of rod, sheet, plate, or tube geometry. In some embodiments, the electrode is oriented with its shorter or shortest dimension forming an angle less than about 45 degrees from normal to the interface between a ClO₂ enriched layer and a liquid electrolyte. In some embodiments, at least one electrode is a sheet or plate, and its normal is aligned approximately parallel to normal of the interface between a ClO₂⁻ enriched layer and a liquid electrolyte. By doing so, a more compact and energy dense electrochemical cell may be produced, and the distance between electrodes and the ClO₂ layer may be reduced, facilitating transport of reacting chemical species and improving the rate with which the cell may be charged and discharged.

In some embodiments, an electrolyte with a high salt concentration is used. While many typical aqueous electrolytes may have a salt concentration of about 1 M, or even less, in some instances the salt concentration may exceed 1 M, or even 5 M or 10 M. Electrolytes with a salt concentration that exceeds the solvent concentration are sometimes referred to as “water in salt” electrolytes, to contrast with typical electrolytes in which the salt is dissolved in water. Without being bound by any particular scientific interpretation, the use of a highly concentrated electrolyte may allow the Cl(III)/Cl(IV) reaction, or the ClO₂⁻/ClO₂ reaction, to be conducted with a decreased rate of competing parasitic or “side” reactions such as the oxygen evolution reaction (OER).

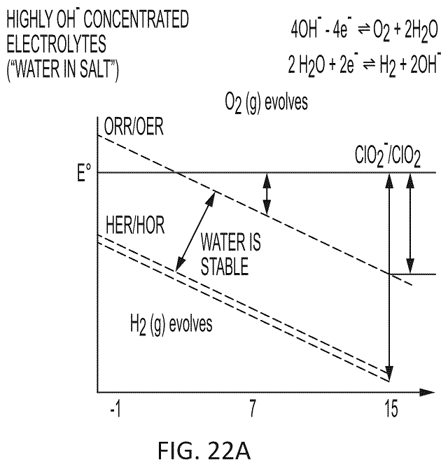

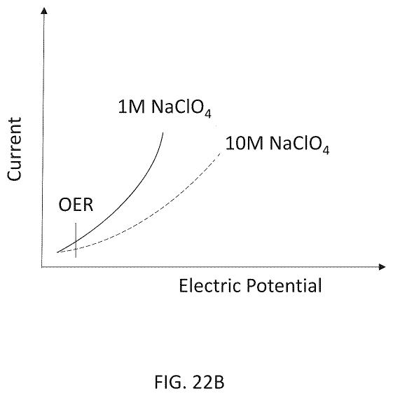

As shown in FIG. 22A, the potential of the ClO₂⁻/ClO₂ reaction is approximately independent of pH, as the redox reaction does not involve H⁺ or OH⁻ ions. At certain electrolyte pH levels, the potential of this redox reaction may exceed the thermodynamic or equilibrium potential of the OER reaction, and the amount by which it is exceeded will increase with increasing pH, increasing the driving force for the OER reaction. However, by using a high salt concentration electrolyte, the OER potential may no longer decrease linearly with increasing pH as shown by the dashed line labeled “ORR/OER” in FIG. 22B, and may flatten instead. Accordingly, the rate of the OER reaction may be suppressed at the potential of the ClO₂⁻/ClO₂ reaction. FIG. 22B is a schematic diagram of this effect: A high salt concentration electrolyte, e.g., 10 M NaClO₄, may have a lower oxygen evolution reaction (OER) rate or current than a lower salt concentration electrolyte, e.g., 1 M NaClO₄, when the electrical potential exceeds the equilibrium potential for the OER reaction indicated by the vertical line.

Indirect Cl(III)/Cl(IV) Electrode without ClO2 Storage, and Batteries and Systems Thereof.

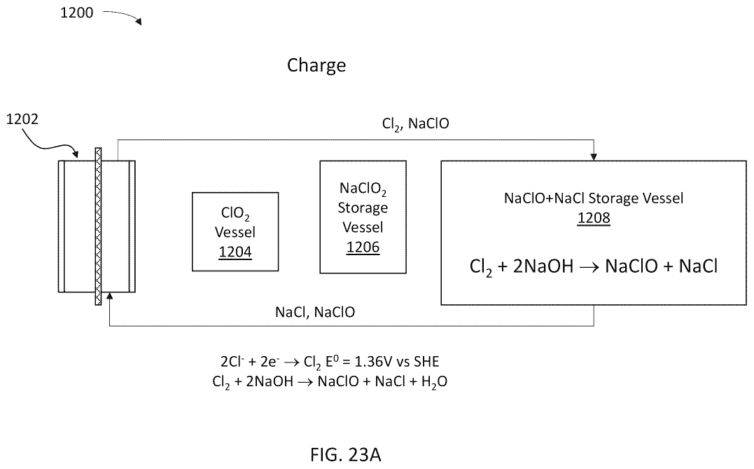

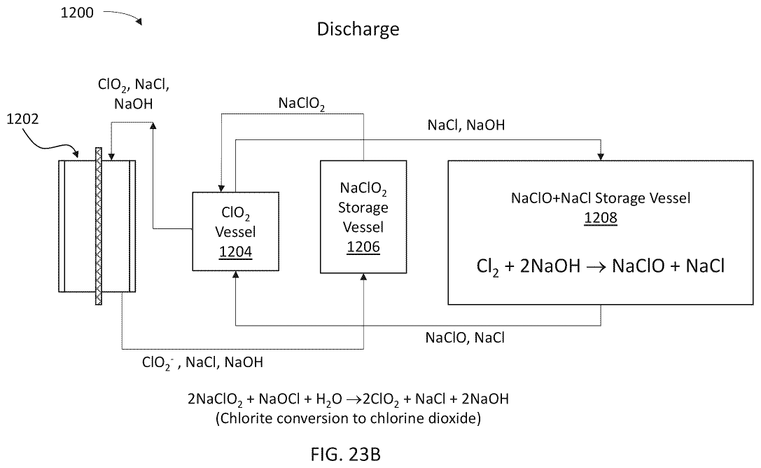

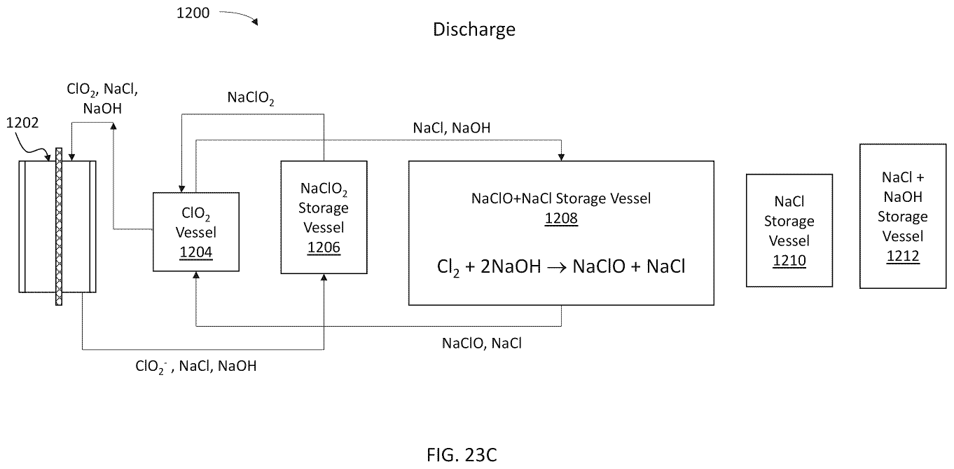

Various embodiments relate to an electrode, electrochemical device, or system in which the ClO₂ to ClO₂⁻ electrochemical reduction reaction is utilized, while the reactant ClO₂ is produced as needed to supply the reaction rather than being stored as ClO₂. Such a system has the advantage of not needing to store or manage a reservoir of ClO₂, which is known to be an unstable chemical under certain conditions. The design and operation of such a system is shown in FIGS. 23A-23B.

Chlorine dioxide may be produced using the chemical reaction: 2NaClO₂+HOCl+HCl→2ClO₂+2NaCl+H₂O. Chlorite to chlorine dioxide conversion of 95-98% is possible via this reaction. In various embodiments, a different reaction, 2NaClO₂+NaOCl+NaCl→2ClO₂+NaCl+2NaOH, is used to produce ClO₂ for the electrode reaction of an electrochemical battery. In such a battery, the ClO₂ is electrochemically reduced to chlorite, ClO₂⁻. In instances in which the chlorite/chlorine dioxide reaction comprises the positive electrode reaction, the reduction of chlorine dioxide to chlorite corresponds to the discharge reaction of the battery.

FIGS. 23A-23B are schematic representations of the operation of a battery system 1200 in which ClO₂ is produced as needed to supply the reaction of ClO₂ to ClO₂⁻. In addition to the electrochemical cell 1202, there may be multiple storage vessels or tanks. There is a ClO₂ “generation” vessel 1204, a NaClO₂ storage vessel 1206, and a NaClO+NaCl storage vessel 1208, each of which may comprise aqueous electrolyte. During charge (FIG. 23A), chlorite is oxidized in the electrochemical cell to molecular chlorine, Cl₂, and optionally some chlorine dioxide, ClO₂ (2Cl—−2e−=>Cl₂E0=1.36V vs SHE). The chlorine gas is reacted with water to produce sodium hypochlorite, NaClO, and sodium chloride, NaCl, and stored in the NaClO+NaCl vessel 1208.

During discharge (FIG. 23B), NaClO₂ from the NaClO₂ storage vessel 1206 is delivered to the ClO₂ vessel 1204, and NaClO and NaCl are delivered from the NaClO+NaCl storage vessel 1208 to the ClO₂ vessel 1204. These reactants are combined in the ClO₂ vessel 1204 and chemically react to produce ClO₂, along with NaCl and NaOH. The ClO₂ may be partially or completely separated from the aqueous solution comprising NaCl and NaOH, either by forming a gas phase or a largely immiscible condensed phase, such as a liquid ClO₂ enriched phase. A portion of the aqueous solution in the ClO₂ vessel 1204, which comprises NaCl and NaOH, is transported to the positive electrode electrochemical cell, along with the ClO₂. A portion of the aqueous solution comprising NaCl and NaOH is returned to the NaClO+NaCl storage vessel 1208, to be reacted with Cl₂. The ClO₂ provided to the positive electrode is reduced to ClO₂⁻ during discharge of the battery. Discharge thus produces a solution comprising dissolved NaClO₂. This aqueous solution may be recirculated back to the NaClO₂ storage vessel, to be used in a subsequent discharge cycle.

The relative amounts of the solution in the ClO₂ vessel 1204 circulated to the electrochemical cell and the NaClO+NaCl storage vessel 1208 may be varied, but generally maintains the NaCl and/or NaOH concentrations and solution volumes in the respective storage vessels.

Referring now to FIG. 23C, in some embodiments, additional storage vessels may be added, such as for supplying an initial chloride ion containing feedstock to the electrochemical cell for charging, such as an NaCl solution storage vessel 1210, and/or an NaCl+NaOH solution storage vessel 1212 (filled the NaCl+NAOH produced by the ClO₂ vessel 1204). In some embodiments, solutions may be transported between two or more storage vessels in the system for various reasons, including the purpose of balancing solution concentrations.

In certain embodiments, the pH of the solution in the ClO₂ vessel 1204 is optimized for ClO₂ generation and short term storage. In some embodiments, the pH of the solution in the NaClO₂ storage vessel 1206 is optimized for stable NaClO₂ storage. In some embodiments, the pH of the solution in the NaClO+NaCl storage vessel 1208 is optimized for stable NaClO storage.

In some embodiments, the indirect Cl(III)/Cl(IV) electrode includes a monofunctional ClO₂ reducing electrode and a chlorine generation electrode. In certain embodiments, the chlorine generation electrode contains materials known for use in chloralkali anodes. In some embodiments, the indirect Cl(III)/Cl(IV) electrode includes a bifunctional electrode for both ClO₂ reduction process and the chlorine generation process. In certain embodiments, the pH of the solution in the ClO₂ vessel is lower than 7. In certain embodiments, the pH of the solution in the NaClO+NaCl is higher than 7.

In some embodiments, the battery is a flow battery, in which the electrochemical cell and one or more of the vessels shown in FIGS. 23A-C are physically separated and are connected to other components of the system by flow channels or pipes. In other embodiments, the electrochemical cell and the vessels or tanks are partially or completely integrated into the same device, forming separate chambers within an assembly or device. In some embodiments, relay controlled valves and pumps are placed in the battery system to control flow between said cell and vessels or tanks. In some embodiments, the flow of fluid between the cell and vessels or tanks is passively driven, including but not limited to thermally driven flow due to local temperature changes in the system, or gas pressure driven due to gas generation or consumption within the system.

Reversible Chlorite/Chlorine Dioxide Anion Redox Couple

Decarbonization of global electricity production will require significant amounts of power storage to be deployed. This creates challenges in terms of both the availability and the scaling of mining and extraction of critical metals such as Li, Co, Ni, V, or Sb, depending on the elemental requirements of the storage technology being used. For battery chemistries that do meet cost and scalability criteria, additional criteria such as energy efficiency (typically represented by coulombic and voltaic efficiency), durability (cycle and calendar life), operating temperature, and safety, come into consideration. However, the ranked importance of such criteria may be unique to each application. There exists a continuing need for new redox couples for rechargeable batteries that can meet current and future needs.

The aqueous chlorine dioxide/chlorite (ClO₂/ClO₂⁻) redox couple has exceptional electrochemical reversibility using catalyst-free, low-cost carbon electrodes. The large crustal abundance of chlorine, which is the highest amongst halogens and is greater than that of nitrogen, makes chlorine attractive as the basis for low-cost, large-scale storage. In particular, the chlorite ion is widely available at low cost when sourced from sodium chlorite (NaClO₂). Furthermore, since oxidation to chlorine dioxide occurs at a standard potential of 0.954V vs SHE, the ClO₂/ClO₂⁻ redox couple is attractive as a positive electrode that can be paired with a wide range of possible negative electrodes, which include low-cost candidates such as Zn or Fe metal electrodes, or S in the form of dissolved polysulfide species. The following Table 3 summarizes the theoretical equilibrium cell voltages of rechargeable batteries using chlorine oxyanion electrochemical couples (e.g., Cl(III)/Cl(IV) couples) as the positive electrode in neutral and alkaline electrolytes.

TABLE 3

| Positive | Negative | | Theoretical Equilibrium |
|---|---|---|---|
| electrode | electrode | Electrolyte | cell voltage |
| ClO₂/ClO₂⁻ | Zn/Zn(OH)₄²⁻ | Alkaline | 2.15 V |
| ClO₂/ClO₂⁻ | Zn/Zn²⁺ | Neutral | 1.72 V |
| ClO₂/ClO₂⁻ | Fe/Fe(OH)₂ | Alkaline | 1.85 V |
| ClO₂/ClO₂⁻ | Fe/Fe²⁺ | Neutral | 1.40 V |
| ClO₂/ClO₂⁻ | S₂²⁻/S₄²⁻ | Alkaline | 1.38 V |

As indicated in Table 3, an alkaline Zn/ClO₂ battery can have a 2.15V equilibrium cell voltage, which ranks amongst the highest of aqueous battery systems. As used herein, the term the “chemical cost of storage energy” is defined as the estimated cost of starting electrode materials and electrolyte divided by stored energy and is used as a metric that represents the minimum cost of any battery system in U.S. dollars per kilowatt hour (thus, chemical cost of storage is represented symbolically herein as “$X/kWh”, where X is the value), and shall be understood to be based on 2022 U.S. dollars. The ClO₂/ClO₂⁻ based battery chemistries described herein, assuming the use of NaClO₂ as a starting material, have estimated chemical costs of $3/kWh-$10/kWh. This estimated chemical cost range compares favorably to comparable estimates of Li-ion chemistries ($20/kWh-$30/kWh), vanadium redox flow batteries (˜$100/kWh), and iron-air batteries ($1.3/kWh). Rechargeable Zn/ClO₂ cells are described herein as an example of this chemistry.

While the electrochemical oxidation of chlorite to chlorine dioxide is the basis for significant commercial production of ClO₂, an industrial chemical most widely used for disinfection, the reverse reaction (electrochemical reduction to ClO₂⁻) has not been extensively studied. Without wishing to be bound by theory, it is believed that the reaction ClO₂-↔ClO2+e− is highly reversible, since only electron transfer is required, rather than atomic bond breaking or formation (e.g., as in chlorine oxidation 2Cl⁻↔H Cl₂+2e−). Simple electron transfer is advantageously used for several transition metal cations used as redox-active battery electrodes in aqueous solution (e.g., Fe(II)/Fe(III), V(II)/V(III), V(IV)/V(V), Cr(II)/Cr(III), Ce(III)/Ce(IV), etc.), particularly in flow batteries.

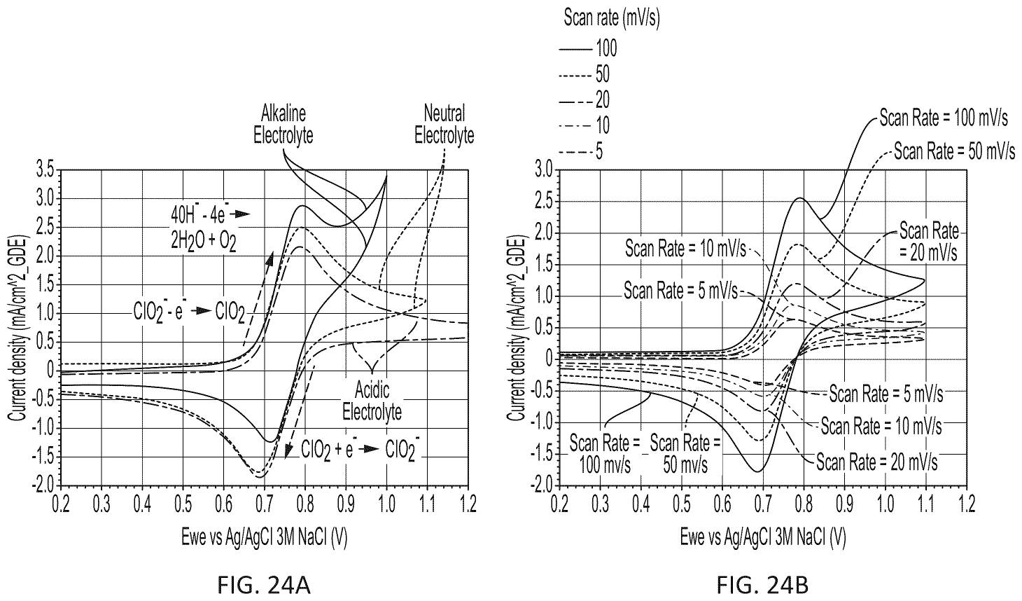

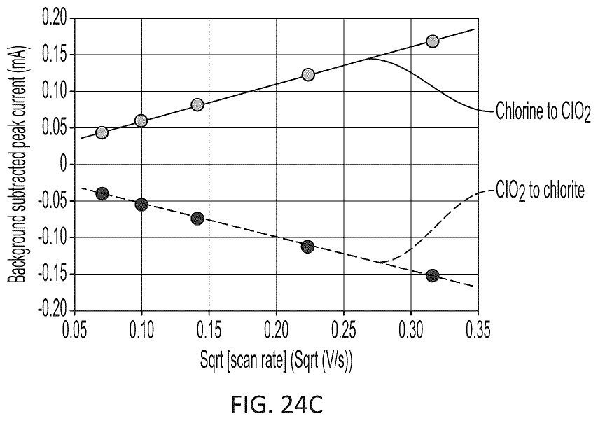

FIG. 24A is a graph showing cyclic voltammetry (CV) of cells including 10 mM NaClO₂ on a glassy carbon electrode (GCE, 3 mm dia.) at a scan rate of 100 mV/sec. FIG. 24B is a graph showing CV for 10 mM NaClO₂ on a glassy carbon electrode (GCE, 3 mm dia.) in 1M NaCl electrolyte at different scan rates. FIG. 24C is a graph showing a Randles-Sevcik analysis based on data from FIG. 10B. All CV experiments were performed at room temperature (19° C.+/−1° C.) using an Ag/AgCl (3M NaCl) reference electrode and a platinum wire counter electrode.

Referring to FIG. 24A, CV curves were taken at the same temperature and sweep rate for acidic, near neutral, and alkaline solutions spanning pH 2 to 14. The supporting electrolyte in the alkaline solution was 1M KOH (about pH 14). The supporting electrolyte in near-neutral solution was 1M NaCl. The supporting electrolyte in the acidic solution was 0.5M Na₂SO₄+9 mM H₂SO₄ (about pH 2). All CV curves were from the third CV cycle. The arrows in the figure indicate the scan direction. The increase in current at higher potential is attributed to the oxygen evolution reaction (OER).

FIG. 24A compares CV curves taken for acidic, near neutral, and alkaline solutions spanning pH 2 to 14, showing that the equilibrium potential of the reaction is independent of pH. This suggests that, as posited above, the half-cell reaction involves electron transfer only. The equilibrium potentials were all within 10 mV of the expected potential of 0.954V (vs. SHE), assuming the standard electrode potential of Ag/AgCl 3M NaCl is 209 mV vs. SHE. If protons were involved in the reaction, a potential shift of 59 mV per pH unit would have been expected to be observed for a 1-electron transfer process.

A pH shift is seen for the oxygen evolution reaction (OER), which occurs at a lower potential (at ˜0.9V vs Ag/AgCl) in the alkaline CV curve than in the neutral or acidic condition in FIG. 10A. These results also show the clear separation in potential between ClO₂/ClO₂⁻ redox and OER, which may be necessary to avoid parasitic loss during charging due to the OER mechanism. To eliminate other possible explanations of the highly reversible electrochemical process other than the proposed ClO₂⁻/ClO₂ couple, cyclic voltammetry of NaClO₃ and NaClO in 1M KOH was performed and electrochemical signals were noticed in either case. Further evidence supporting chlorine dioxide formation in the electrochemical reaction was the observation of its characteristic yellow color in the aqueous electrolyte after oxidation. In bulk electrolysis half-cells, when using a high surface area vitreous carbon electrode, this was observed as an increase the extent of reaction, as well as in full cells described below.

Referring to FIG. 24B, CV curves in near-neutral solution at room temperature are shown for sweep rates from 100 to 5 mV/sec. There was a minimal drift of the equilibrium voltage (<2 mV) with scan rate. The electrolyte iR corrected peak-to-peak separation slightly increased from 72 mV to 95 mV at 100 mV/sec.

Referring to FIG. 24C, the Randalls-Sevcik analysis of the results in FIG. 10B show highly linear cathodic and anodic fits, indicative of a diffusion controlled electrochemical reaction. The diffusivity of the “reduced/discharged” active species (i.e., chlorite) was estimated from the slope of the anodic peak current (i.e., above the X-axis) to be 7.0×10⁻⁶ cm²/sec. The diffusivity of the “oxidized/charged” active species (i.e., chlorine dioxide) was estimated from the slope of the cathodic peak current (i.e., below the X-axis) to be 5.7×10⁻⁶ cm²/sec. A difference in diffusivity of the charged and the discharged species is expected due to different solvation structures for the chlorite ion and the chlorine dioxide molecule in the electrolyte.

As a storage electrode, ClO₂ may be stored in either a gaseous or liquid phase. The currently described experiments span the boiling point of ClO₂, which is 11° C. at one atmosphere pressure. These experiments confirm that the reaction has good electrochemical reversibility both above and below the boiling point of ClO₂, as described in greater detail below. Indeed, the separation in potential between oxidation and reduction peaks, as well as the magnitude of the peak currents, are nearly the same between 5° C. and 20° C. For practical application in battery systems, storage as a condensed phase is desirable for higher energy density and ease of containment. Note that liquid ClO₂ is immiscible with aqueous electrolytes and has a higher density of 1.64 g/cm³. These features facilitate the storage of ClO₂ as a separate liquid phase, without resorting to high pressures and facilitates the use density-based separation, as described in greater detail below.

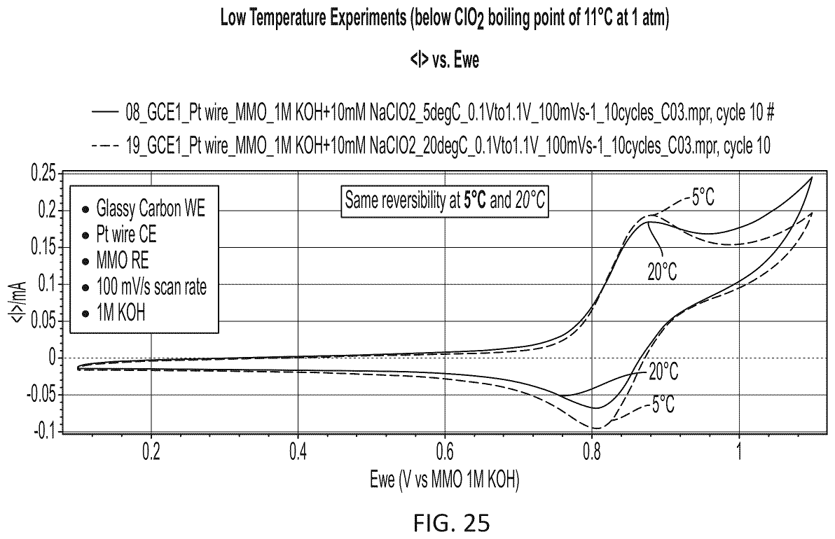

FIG. 25 is a graph showing cyclic voltammetry (CV) results of 10 mM NaClO₂ in 1M KOH solution using a glassy carbon electrode (3 mm dia.) at a scan rate of 100 mV/sec in a water-jacketed glass cell, at 5° C. and 20° C. The cell temperature was controlled by circulating water held at the temperature of interest. An Ag/AgCl (3M NaCl) reference electrode and a platinum wire counter electrode were used in the cells.

To demonstrate use of the ClO₂⁻/ClO₂ couple in a full cell, Zn—ClO₂ cells were prepared and tested while operating with near-neutral electrolyte at temperature of 0.5±0.5° C., where any ClO₂ phase produced is liquid. The Zn—ClO₂ couple has the highest theoretical equilibrium cell voltage of the anode-cathode combinations considered above, 1.72V (Table 3), which is about 0.5V higher than that of several well-known aqueous rechargeable chemistries such the Fe—Ni “Edison” battery (1.4V), Ni—Cd battery (1.2 V), vanadium redox flow battery (1.26V), and the all-Fe redox battery (1.2V). In alkaline media, when Zn metal and NaClO₂ (dissolved in the electrolyte) are used as the starting materials, it is necessary to perform a first charging step to produce ClO₂, at the negative electrode, during which hydrogen evolution occurs at the positive electrode, according to the negative electrode half-cell charging reaction (Reaction 4), the positive electrode half-cell charging reaction (Reaction 5), and the full cell charging reaction (Reaction 6):

2H₂O+2e−↔H₂+2OH⁻; Reaction 4:

2ClO₂₋↔2ClO₂+2e⁻; and Reaction 5:

2H₂O+2ClO₂_{^{−}}↔H₂+2OH—+2ClO₂. Reaction 6:

With ClO₂ formed, the cell is in the fully charged state with Zn and ClO₂ present at negative and positive electrodes, respectively, and may be operated reversibly, with the negative electrode half-cell discharging reaction (Reaction 7), the positive electrode half-cell discharging reaction (Reaction 8), and the full cell charging reaction (Reaction 9):

Zn+2OH⁻↔Zn(OH)₂+2e⁻; Reaction 7:

2ClO₂+2e⁻↔2ClO₂⁻; and Reaction 8:

Zn+2OH⁻+2ClO₂↔Zn(OH)₂+2ClO₂_{^{−}}. Reaction 9:

Assuming a balanced cell with equal capacity at the negative and positive electrodes, an alkaline electrolyte containing NaClO₂ as the sole source of working chlorite ions, and assuming that the ClO₂ formed upon charge is present as a pure liquid, the theoretical energy density is calculatable. This energy density is primarily limited by the solubility of NaClO₂ in the electrolyte, which was independently determined to be 2 M and 3 M at 0° C. and 20° C., respectively. The corresponding calculated energy density values are 77 Wh/L and 106 Wh/L, and the estimated chemical cost of stored energy (cost of Zn and electrolyte components divided by the stored energy) is 7.3$/kWh. This estimated chemical cost is significantly lower than estimates for Li-ion, Ni—Cd and NiMH batteries ($30/kWh-80$/kWh) as well as estimates for vanadium redox flow batteries (100$/kWh) and is comparable to estimates for primary Zn/MnO₂ and high temperature rechargeable Na/NiCl2 batteries.

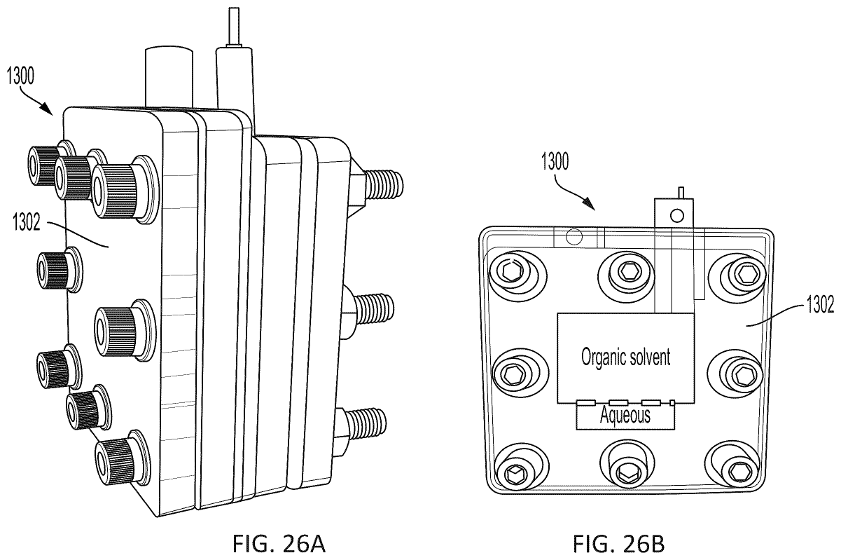

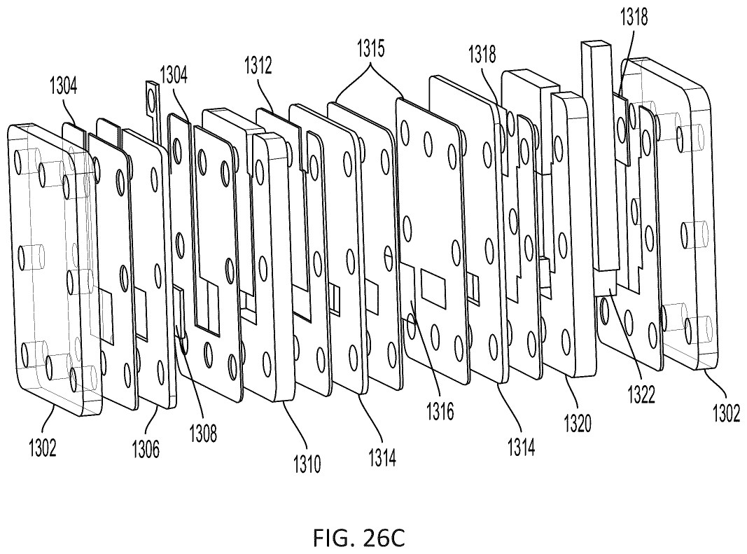

Referring to FIGS. 26A-26C, a full cell 1300 may include end plates 1302, anode gaskets 1304, an anode plate 1306, an anode 1308, a RE plate 1310, an RE plate gasket 1312, membrane plates 1314, membrane gaskets 1315, a membrane 1316, cathode gaskets 1318, a cathode plate 1320, and a cathode 1322. A first instance of the anode gasket 1304 is disposed between a first instance of the end plate 1302 and the anode plate 1306. A second instance of the anode gasket 1304 is sandwiched between the anode plate 1306 and the RE plate 1310. The anode 1308 is disposed between the anode plate 1306 and the RE plate 1310 with the second instance of the anode gasket 1304 providing sealing about the anode 1308. The RE plate 1310 is disposed between the second instance of the anode gasket 1304 and the RE plate gasket 1312. A first instance of the membrane plate 1314 is disposed between the RE plate gasket 1312 and a first instance of the membrane gasket 1315. The membrane 1316 is sandwiched between the first instance of the membrane gasket 1315 and a second instance of the membrane gasket 1315. The second instance of the membrane plate 1314 is disposed between the second instance of the membrane gasket 1315 and a first instance of the cathode gasket 1318. In turn, the first instance of the cathode gasket 1318 is disposed between the second instance of the membrane plate 1314 and the cathode plate 1320. The cathode 1322 is disposed between the cathode plate 1320 and a second instance of the cathode gasket 1318. A second instance of the end plate 1302 supports the second instance of the cathode gasket 1318 to the cathode plate 1320 such that the cathode 1322 is sandwiched between the cathode plate 1320 and the second instance of the end plate 1302.

Initial full-cell experiments conducted in three-electrode beaker-type cells led to the flat cell design as shown, which was used to obtain the results below. Two likely parasitic reactions were recognized in the initial full-cell experiments conducted in three-electrode beaker-type cells, and the cell design was adapted to reduce such reactions. Without wishing to be bound by theory, one such parasitic reaction is believed to be the reaction that occurs between Zn metal and ClO₂⁻, forming solid Zn(OH)₂ and water. The constructed full cell included a zinc sheet negative electrode and vitreous carbon foam positive electrode, separated by a Nafion™ 117 membrane (available from The Chemours Company of Wilmington, Delaware, United States) that was pre-soaked in an NaOH solution to provide Na+ ion conductivity, while significantly blocking the crossover of chlorite ions, thereby mitigating this side reaction.

Again without wishing to be bound by theory, a second parasitic reaction is believed to be the disproportionation reaction ClO₂+H₂O↔ClO₂⁻+ClO₃⁻+2H⁺. To reduce the likelihood of this reaction, the ClO₂ may be exsolved as a separate liquid phase, taking advantage of its low solubility in water, thus reducing contact. Additionally, or alternatively, separating ClO₂ from water may include providing a separate, immiscible, organic phase in which the ClO₂ is soluble, as an accumulator phase. This approach decreases energy density but has the advantage of lowering the vapor pressure of ClO₂. Several organic liquids having significant solubility for ClO₂ are known; here a synthetic saturated hydrocarbon solvent was selected with a similar range of carbon number to that of Diesel fuel, a ClO₂ solubility of about 4 g/L, and that segregates as a surface layer on the aqueous electrolyte due to its lower density (FIGS. 26A and 26B). For the proportions of each material used in the presently described experiments, two-thirds of the ClO₂ produced resides in the accumulator phase at equilibrium and is separated from the aqueous electrolyte in which disproportionation may occur. The distribution of ClO₂ between the accumulator phase and the aqueous electrolyte may be further varied through the choice of organic phase and the relative amounts of these two phases.

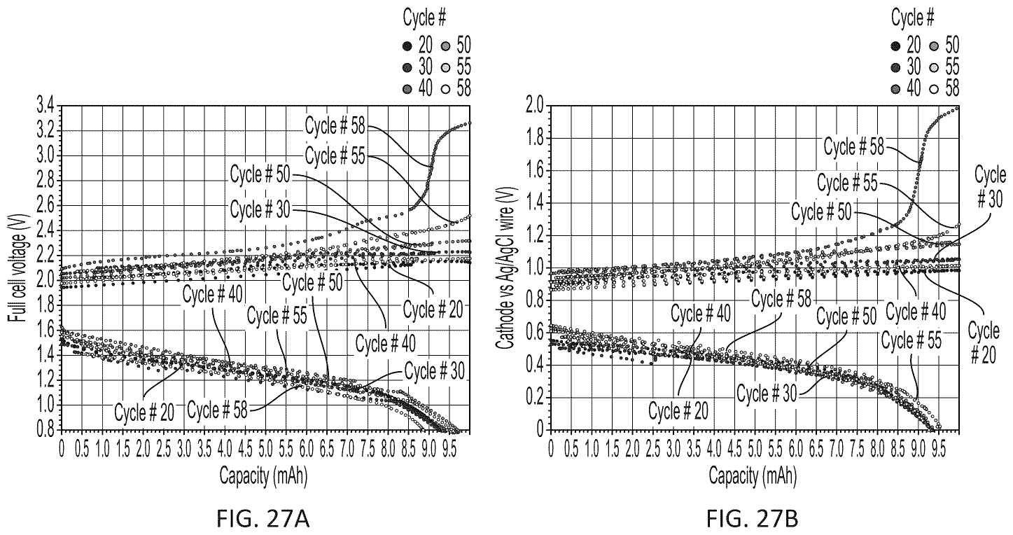

FIGS. 27A and 27B are graphs showing charge and discharge capacity and the cathode vs. reference electrode capacity, of the full cell 1300 shown in FIGS. 26A-26C. Referring to FIGS. 13A and 13B, the results obtained from a representative Zn—ClO₂ full cell tested at 0.5° C.±0.5° C., plotted as cell voltage vs capacity for a capacity-limited cycling regimen wherein galvanostatic charging at a current density of 5 mA/cm² up to a capacity limit of 10 mAh was performed, followed by discharging to a voltage limit of 0.8V. The positive electrolyte included a 1.5 mL volume of 1.95 mol/L NaClO₂ solution, on top of which floated 6 mL of a hydrocarbon solvent in which ClO₂ is soluble. The negative electrolyte included a 3 mL volume having 0.96 mol/L ZnCl₂ and 0.98 mol/L NaCl. A silver/silver chloride (Ag/AgCl) wire pseudo reference electrode was placed in the negative electrolyte of the cell. A piece of sodiated Nafion™ 117 (Na—N117, available from The Chemours Company of Wilmington, Delaware, United States) separated the positive electrolyte and the negative electrolyte.

The open-circuit voltage (OCV) of the cell was 1.7V, close to the theoretical value, after charging to 10% state-of-charge (SOC). Reversible cycling was observed, with a coulombic efficiency of 92-96% over the first 50 cycles. By comparison, beaker-type cells without either the Nafion membrane or the organic solvent accumulator exhibited a coulombic efficiency of less than 50%.

For the flat cells, after about 50 cycles, a step change in charge voltage emerged at a high SOC. A similar feature is seen in the plot of cathode-reference potential vs. capacity in FIG. 24B, demonstrating that the step change is related to a positive electrode reaction. It is believed that this feature can be attributed to the onset of OER at the cathode, which is associated with a loss of working ClO₂/ClO₂⁻ resulting in OER when the cell is “overcharged.” The voltage plateau at 1.9-2.0 V (vs Ag/AgCl) in FIG. 24B is considerably higher than the theoretical OER potential in a near-neutral solution of 0.6V (vs Ag/AgCl). However, the existence of a high kinetic overpotential for OER at the surface of carbon electrodes is well-known. Without wishing to be bound by theory, it is believed that loss of ClO₂/ClO₂⁻ may be attributable to any one or more of incomplete blocking of chlorite crossover to the Zn electrode, partial disproportionation of ClO2 in the electrolyte, or possible leakage of ClO₂ from the cell.

These loss mechanisms may be further mitigated by improvements in cell design, including implementation in half-flow or flow-battery designs. Treating the cell in FIGS. 26A-26C as the power-generating stack of a flow battery, the ClO2 product could be stored in a tank and circulated to the positive electrode. The zinc negative electrode is likely stationary, but circulation of the alkaline electrolyte may have similar advantages to those in Zn-air cell designs such as suppression of metal dendrites. The independent scaling of tank storage and stack power generation that is inherent in flow-battery designs means that the system could be tailored to address storage needs over a wide range of durations, including long-duration storage. Finally, the rapid redox kinetics combined with stability of ClO2 in the liquid phase at ambient pressures below about 11° C. suggests that chlorite based batteries may be especially attractive for low temperature stationary storage, including arctic, Antarctic, and/or extraterrestrial applications.

According to various embodiments, the ClO₂⁻/ClO₂ electrochemical reaction is shown to be highly reversible in acidic, near-neutral, and alkaline electrolytes while using low-cost carbon electrodes. Its equilibrium potential (0.954 V vs SHE) is pH-independent and facilitates high aqueous cell voltages of 1.38-2.15 V when used as a positive electrode in conjunction with negative electrodes such as Zn, Fe, or S electrodes. This anion redox couple may facilitate production of low-cost aqueous rechargeable batteries, free or substantially free of resource-constrained metals. The rapid reaction kinetics and stability of the ClO₂ phase at low temperatures also suggests that chlorite-based batteries may be favorable for applications in cold environments.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

Various examples are provided below to illustrate aspects of the various embodiments. Example 1. An electrode which performs electrochemical oxidation and reduction of oxyanions. Example 2. The electrode of example 1 which performs electrochemical conversions between nitrate, nitrite, and ammonia, the electrode comprising an aqueous solution of sodium nitrate, potassium nitrate, lithium nitrate, magnesium nitrate, calcium nitrate, calcium ammonium nitrate, sodium nitrite, potassium nitrite, lithium nitrite, or mixtures thereof. Example 3. The electrode of example 1 which performs electrochemical conversions between sulfate, sulfite, hyposulfite, thiosulfate, dithionite, and hydrogen sulfide, the electrode comprising an aqueous solution of sodium sulfate, potassium sulfate, magnesium sulfate, ammonium sulfate, sodium sulfite, potassium sulfite, or mixtures thereof. Example 4. The electrode of example 1 which performs electrochemical conversions between phosphate, phosphite, and hypophosphite, the electrode comprising an aqueous solution of sodium phosphate, potassium phosphate, disodium hydrogen phosphite, diammonium hydrogen phosphite, or mixtures thereof. Example 5. An energy storage device in which: the device charges with electrical energy by an electrochemical process; the device releases electrical energy by an electrochemical process; and one or more electrodes are as described by examples 2, 3, or 4, wherein an electrochemical reaction of oxyanions occurs. Example 6. The device in example 5 wherein the cathode uses atmospheric oxygen and is comprised either of: a single bifunctional electrode with performs both oxidation and reduction of atmospheric oxygen; or a dual electrode cathode, with distinct electrodes to perform oxidation and reduction of atmospheric oxygen. Example 7. The device in example 5 wherein the cathode comprises of iron (III)/iron (II) cations, molecular chlorine/chloride, molecular bromine/bromide, and/or manganese (II) oxide/manganese (II) hydroxide. Example 8. The device in example 5 wherein both the anode and cathode comprise aqueous solutions of oxyanions, separated by an ion-exchange membrane. Example 9. The device in example 5 wherein reduction of oxyanions is performed by microbial activity. Example 10. The device in example 5 wherein the energy storage media is cycled in a flow battery. Example 11. A bulk energy storage system, comprising at least one energy storage device of any of examples 5-10; and/or at least one energy storage device having an electrode of any of examples 1-4. Example 12. The bulk energy storage system of example 11, wherein the bulk energy storage system is a long or ultra-long duration energy storage system.

Example A1. An energy storage device, comprising: at least one electrode configured such that electrochemical oxidation and reduction of one or more redox-active oxyanions occurs during charging and/or discharging of the energy storage device. Example A2. The energy storage device of example A1, wherein at least one of the one or more redox-active oxyanions comprise nitrate (NO₃²⁻), nitrite (NO₂²⁻), sulfate (SO₄²⁻), sulfite (SO₃²⁻), hyposulfite (SO₂²⁻), phosphate (PO₄³⁻), phosphite (PO₃³⁻), hypophosphite (PO₂³⁻), peroxodisulfate (S₂O₈²⁻), ammonia (NH₃), ammonium (NH₄⁺), S₂⁻, HS₂, chlorite (ClO₂⁻), chlorate (ClO₃⁻), chlorine dioxide (ClO₂), or hypochlorite (ClO⁻). Example A3. The energy storage device of example A1, wherein the energy storage device is configured such that electrochemical conversions between nitrate, nitrite, and/or ammonia occur during charging and/or discharging of the energy storage device. Example A4. The energy storage device of example A3, wherein the electrode comprises an aqueous solution of sodium nitrate, potassium nitrate, lithium nitrate, magnesium nitrate, calcium nitrate, calcium ammonium nitrate, sodium nitrite, potassium nitrite, lithium nitrite, or mixtures thereof. Example A5. The energy storage device of example A1, wherein the energy storage device is configured such that electrochemical conversions between sulfate, sulfite, hyposulfite, thiosulfate, dithionite, and/or hydrogen sulfide occur during charging and/or discharging of the energy storage device. Example A6. The energy storage device of example A5, wherein the electrode comprises an aqueous solution of an aqueous solution of sodium sulfate, potassium sulfate, magnesium sulfate, ammonium sulfate, sodium sulfite, potassium sulfite, or mixtures thereof. Example A7. The energy storage device of example A1, wherein the energy storage device is configured such that electrochemical conversions between phosphate, phosphite, and hypophosphite occur during charging and/or discharging of the energy storage device. Example A8. The energy storage device of example A1, wherein the electrode comprises an aqueous solution of sodium phosphate, potassium phosphate, disodium hydrogen phosphite, diammonium hydrogen phosphite, or mixtures thereof. Example A9. The energy storage device of example A1, wherein the one or more redox-active oxyanions comprise nitrate and/or nitrite anions. Example A10. The energy storage device of any of examples A1-A9, wherein the electrode comprises a bifunctional air electrode configured to perform oxygen reduction reactions and oxygen evolution reactions. Example A11. The energy storage device of any of examples A1-A9, wherein the electrode comprises a dual electrode configuration comprising: an oxygen reduction reaction (ORR) electrode; and an oxygen evolution reaction (OER) electrode separate from the ORR electrode. Example A12. The energy storage device of any of examples A1-A11, wherein the electrode is a cathode that comprises a cathode active material selected from iron (III)/iron (II) cations, molecular chlorine/chloride, molecular bromine/bromide, manganese (II) oxide/manganese (II) hydroxide, or any combination thereof. Example A13. The energy storage device of any of examples A1-A12, comprising: an anode; and a cathode, wherein the anode and/or the cathode are the electrode according to examples A1-A12 and both the anode and the cathode comprise aqueous solutions of oxyanions; and an ion exchange membrane disposed between the anode and the cathode. Example A14. The energy storage device of any of examples A1-A13, further comprising: one or more biomolecules, one or more enzymes, and/or one or more microorganisms disposed within the energy storage device, wherein the one or more biomolecules, the one or more enzymes, and/or the one or more microorganisms aid in oxidation and/or reduction of the one or more redox-active oxyanions during charging and/or discharging of the energy storage device. Example A15. The energy storage device of example A14, wherein the one or more biomolecules, one or more enzymes, and/or one or more microorganisms disposed within the energy storage device are at least one microorganism. Example A16. The energy storage device of example A15, wherein the at least one microorganism is a bacteria. Example A17. The energy storage device of example A16, wherein the bacteria is a sulphate-reducing bateria. Example A18. The energy storage device of any of examples A1-A17, wherein the energy storage device is a flow battery. Example A19. An energy storage device, comprising: negative electrode materials comprising sulfate and sulfite; and positive electrode materials comprising oxygen, wherein the energy storage device is configured to be rechargeable. Example A20. A bulk energy storage system, comprising one or more energy storage devices of any of examples A1-A19. Example A21. The bulk energy storage system of example A20, wherein the bulk energy storage system is a long or ultra-long duration energy storage system.

Example B1. 1. An electrochemical system, comprising: a first electrode; and a second electrode, wherein the electrochemical system stores energy and/or discharges energy by an electrode reaction of a halogenated oxyanion species. Example B2. The electrochemical system of example B1, wherein the storing of energy and/or the discharging of energy by the electrode reaction of the halogenated oxyanion species comprises storing energy and discharging energy by a reversable electrode reaction between a chlorine containing ion and chlorine dioxide. Example B3. The electrochemical system of example B2, wherein the chlorine containing ion comprises a salt. Example B4. The electrochemical system of example B3, wherein the salt is an alkali metal salt. Example B5. The electrochemical system of any of examples B1-B4, wherein the electrochemical system comprises a storage battery. Example B6. The electrochemical system of any of examples B1-B5, further comprising a current collector comprising a metal or metal compound. Example B7. The electrochemical system of example B6, wherein the current collector comprises carbon. Example B8. The electrochemical system of any of examples B1-B7, wherein the system is a bulk energy storage system is a long duration energy storage (LODES) system. Example B9. A method of operating an electrochemical system, the method comprising: storing and/or discharging energy by an electrode reaction of a halogenated oxyanion species. Example B10. The method of example B9, wherein storing and/or discharging energy by an electrode reaction of a halogenated oxyanion species comprises storing and/or discharging energy by a reversable electrode reaction between a chlorine containing ion and chlorine dioxide. Example B11. The method of example B10, wherein the chlorine containing ion comprises a salt. Example B12. The method of example B11, wherein the salt is an alkali metal salt. Example B13. The method of any of examples B9-B12, wherein the storing and/or discharging are performed as part of operating a battery in a bulk energy storage system. Example B14. The method of example B13, wherein the bulk energy storage system is a long duration energy storage (LODES) system. Example B15. An energy storage device, comprising: negative electrode materials; and positive electrode materials comprising chlorine dioxide and chlorite, wherein the energy storage device is configured to be rechargeable. Example B16. The energy storage device of example B15, further comprising an electrolyte, wherein the negative electrode materials comprise carbon, zinc, iron, or sulfur. Example 17. A bulk energy storage system, comprising one or more energy storage devices of any of examples B15-B16. Example B18. The bulk energy storage system of example B17, wherein the bulk energy storage system is a long or ultra-long duration energy storage system.

The preceding description of the disclosed embodiments is provided to enable any person skilled in the art to make or use the described embodiment. Further, any step of any embodiment described herein can be used in any other embodiment. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the following claims and the principles and novel features disclosed herein.

What is claimed is:

1. An electrochemical system, comprising:
a first electrode; and
a second electrode,
wherein the electrochemical system stores energy and/or discharges energy by an electrode reaction of a halogenated oxyanion species.

2. The electrochemical system of claim 1, wherein the storing of energy and/or the discharging of energy by the electrode reaction of the halogenated oxyanion species comprises storing energy and discharging energy by a reversable electrode reaction between a chlorine containing ion and chlorine dioxide.

3. The electrochemical system of claim 2, wherein the chlorine containing ion comprises a salt.

4. The electrochemical system of claim 3, wherein the salt is an alkali metal salt.

5. The electrochemical system of any of claim 1, wherein the electrochemical system comprises a storage battery.

6. The electrochemical system of any of claim 1, further comprising a current collector comprising a metal or metal compound.

7. The electrochemical system of claim 6, wherein the current collector comprises carbon.

8. The electrochemical system of any of claim 1, wherein the system is a bulk energy storage system is a long duration energy storage (LODES) system.

9. A method of operating an electrochemical system, the method comprising:
storing and/or discharging energy by an electrode reaction of a halogenated oxyanion species.

10. The method of claim 9, wherein storing and/or discharging energy by an electrode reaction of a halogenated oxyanion species comprises storing and/or discharging energy by a reversable electrode reaction between a chlorine containing ion and chlorine dioxide.

11. The method of claim 10, wherein the chlorine containing ion comprises a salt.

12. The method of claim 11, wherein the salt is an alkali metal salt.

13. The method of any of claim 9, wherein the storing and/or discharging are performed as part of operating a battery in a bulk energy storage system.

14. The method of claim 13, wherein the bulk energy storage system is a long duration energy storage (LODES) system.

15. An energy storage device, comprising:
negative electrode materials; and
positive electrode materials comprising chlorine dioxide and chlorite,
wherein the energy storage device is configured to be rechargeable.

16. The energy storage device of claim 15, further comprising an electrolyte, wherein the negative electrode materials comprise carbon, zinc, iron, or sulfur.

17. A bulk energy storage system, comprising the energy storage devices of claim 15.

18. The bulk energy storage system of claim 17, wherein the bulk energy storage system is a long or ultra-long duration energy storage system.
